(19) United States
(12) Patent Application Publication
(10) Pub. No.: US 2023/0007130 A1
(43) Pub. Date: Jan. 5, 2023

(54) MANAGEMENT SYSTEM, MANAGEMENT METHOD, AND RECORDING MEDIUM

(71) Applicant: NEC Corporation, Minato-ku, Tokyo (JP)

(72) Inventor: Masaya NAKATSUKA, Tokyo (JP)

(73) Assignee: NEC Corporation, Minato-ku, Tokyo (JP)

(21) Appl. No.: 17/784,834

(22) PCT Filed: Dec. 25, 2019
(86) PCT No.: PCT/JP2019/050789

§ 371 Date: Jun. 13, 2022

(51) Int. Cl. H04N 1/00; G06T 7/73

(52) U.S. Cl. CPC H04N 1/00127; G06T 7/74; H04N 2201/3205

(57) ABSTRACT

A management system is configured to include a first data acquisition unit, a second data acquisition unit, and a comparison unit. The first data acquisition unit acquires first image data obtained by capturing an image of a first object, and identification information about the owner of the first object. The second data acquisition unit acquires second image data obtained by capturing an image of a second object. The comparison unit 3 identifies the identification information about the owner of the first object by comparing the characteristics of the surface pattern of the first object as represented by the first image data with the characteristics of the surface pattern of the second object as represented by the second image data.

### TECHNICAL FIELD

The present invention relates to a technique for managing an object, and particularly relates to a technique for managing an object using a surface shape unique to an individual.

### BACKGROUND ART

When there is an object whose owner is unknown in a facility or the like used by a large number of people, such as a lost item in public transport, it is often difficult to specify the owner of the object. In a facility or the like with a high security management level, it is also often difficult to determine whether an object possessed by a leaving person is the belongings of the person or another object of the same or similar type. On the other hand, in such a facility that many people use, it is desirable that check of belongings at entry/exit is simplified as much as possible. Therefore, it is desirable to have a technique that facilitates specification of the owner of an object while reducing the burden on the user required to check the belongings. As a technique that facilitates specification of the owner of another object of the same or similar type, for example, a technique such as PTL 1 is disclosed.

PTL 1 relates to a management system that specifies the owner of an object based on a mark identifier added to the object. In PTL 1, at the time of purchase of an object, a mark is inscribed at a different position for each object, and a mark identifier is added. The information of the mark identifier for each object is registered in association with the information of the owner of the object. When it is desired to specify the owner of an object, by reading the mark identifier of the object and collating it with registered information, the owner is specified. PTL 2 discloses a technique for identifying an object by reading information of a tag attached to the object, the tag in which identification information of the owner is recorded. PTL 3 discloses a technique for identifying an object by reading a two-dimensional barcode in which identification information unique to an individual is recorded.

### CITATION LIST

### Patent Literature

[PTL 1] WO 2019/111811
[PTL 2] JP 2006-154977 A
[PTL 3] JP 2016-177464 A

### SUMMARY OF INVENTION

### Technical Problem

However, the technique of PTL 1 is not sufficient in the following points. In PTL 1, a mark identifier is added to an object at the time of purchase of the object, and registered in association with owner information. In PTL 1, a tool for adding, to an object, a mark identifier that does not disappear by use or custody, and a technique for inscribing a mark on the object to add the mark identifier are required. Therefore, since it is not easy for the owner himself to register the identification information of the object after purchase, there is a possibility that the information of the mark identifier does not exist in a specific target object when the owner is specified. Also in PTLs 2 and 3, it is necessary to attach in advance a tag or a two-dimensional barcode in which identification information is recorded to an object at the time of sale or the like, and it is difficult for the owner to register the identification information later. Therefore, the techniques of PTLs 1 to 3 are not sufficient as a technique for specifying the owner of an object without requiring complicated work by the user.

In order to solve the above problems, an object of the present invention is to provide a management system capable of specifying the owner of an object without requiring complicated work.

### Solution to Problem

In order to solve the above problem, a management system of the present invention includes a first data acquisition unit, a second data acquisition unit, and a collation unit. The first data acquisition unit acquires first image data in which a first object is photographed and identification information of the owner of the first object. The second data acquisition unit acquires second image data in which a second object is photographed. The collation unit specifies the identification information of the owner of the first object by collating the feature of the surface pattern of the first object in the first image data with the feature of the surface pattern of the second object in the second image data.

A management method of the present invention includes acquiring the first image data in which the first object is photographed and the identification information of the owner of the first object. The management method of the present invention includes acquiring the second image data in which the second object is photographed. The management method of the present invention includes specifying the identification information of the owner of the first object by collating the feature of the surface pattern of the first object in the first image data with the feature of the surface pattern of the second object in the second image data.

A recording medium of the present invention records a computer program for causing a computer to execute processing. The computer program causes the computer to execute processing of acquiring the first image data in which the first object is photographed and the identification information of the owner of the first object. The computer program causes the computer to execute processing of acquiring the second image data in which the second object is photographed. The computer program causes the computer to execute processing of specifying the identification information of the owner of the first object by collating the feature of the surface pattern of the first object in the first image data with the feature of the surface pattern of the second object in the second image data.

### Advantageous Effects of Invention

According to the present invention, it is possible to specify the owner of an object without requiring complicated work.

### BRIEF DESCRIPTION OF DRAWINGS

FIG. 1A is a view illustrating a configuration of a first example embodiment of the present invention.

FIG. 1B is a view illustrating an operation flow of a management system of the first example embodiment of the present invention.

FIG. 2 is a view illustrating a configuration of a second example embodiment of the present invention.

FIG. 3 is a view illustrating an application example of a management system of the second example embodiment of the present invention.

FIG. 4 is a view illustrating a configuration of a user information management device of the second example embodiment of the present invention.

FIG. 5 is a view illustrating a configuration of a collation device of the second example embodiment of the present invention.

FIG. 6 is a view illustrating a configuration of a manager terminal device of the second example embodiment of the present invention.

FIG. 7 is a view illustrating an example of a photographing method of an image of an object of the second example embodiment of the present invention.

FIG. 8 is a view illustrating an operation flow of the user information management device of the second example embodiment of the present invention.

FIG. 9 is a view illustrating an operation flow of the manager terminal device of the second example embodiment of the present invention.

FIG. 10 is a view illustrating an operation flow of the collation device of the second example embodiment of the present invention.

FIG. 11 is a view illustrating another application example and modification of a management system of the second example embodiment of the present invention.

FIG. 12 is an operation flow of the manager terminal device of the second example embodiment of the present invention, and is a view illustrating an operation flow in the another application example illustrated in FIG. 11.

FIG. 13 is an operation flow of the user information management device of the second example embodiment of the present invention, and is a view illustrating an operation flow in the another application example illustrated in FIG. 11.

FIG. 14 is an operation flow of the collation device of the second example embodiment of the present invention, and is a view illustrating an operation flow in the another application example illustrated in FIG. 11.

FIG. 15 is a view illustrating a configuration of a third example embodiment of the present invention.

FIG. 16 is a view illustrating a configuration of an entry/exit device of the third example embodiment of the present invention.

FIG. 17 is a view illustrating a configuration of an object management device of the third example embodiment of the present invention.

FIG. 18 is a view illustrating a configuration of a collation device of the third example embodiment of the present invention.

FIG. 19 is a view illustrating an operation flow of the entry/exit device of the third example embodiment of the present invention.

FIG. 20 is a view illustrating an operation flow of the object management device of the third example embodiment of the present invention.

FIG. 21 is a view illustrating an operation flow of the collation device of the third example embodiment of the present invention.

FIG. 22 is a view illustrating an application example of a management system of the third example embodiment of the present invention.

FIG. 23 is a view illustrating the application example of the management system of the third example embodiment of the present invention.

FIG. 24 is a view illustrating a configuration of a fourth example embodiment of the present invention.

FIG. 25 is a view illustrating a configuration of an entry/exit device of the fourth example embodiment of the present invention.

FIG. 26 is a view illustrating a configuration of an object management device of the fourth example embodiment of the present invention.

FIG. 27 is a view illustrating a configuration of a terminal device of the fourth example embodiment of the present invention.

FIG. 28 is a view illustrating an operation flow of the terminal device of the fourth example embodiment of the present invention.

FIG. 29 is a view illustrating an operation flow of the entry/exit device of the fourth example embodiment of the present invention.

FIG. 30 is a view illustrating an operation flow of the object management device of the fourth example embodiment of the present invention.

FIG. 31 is a view illustrating an application example of a management system of the fourth example embodiment of the present invention.

FIG. 32 is a view illustrating the application example of the management system of the fourth example embodiment of the present invention.

FIG. 33 is a view illustrating an example of another configuration of the present invention.

### EXAMPLE EMBODIMENT

### First Example Embodiment

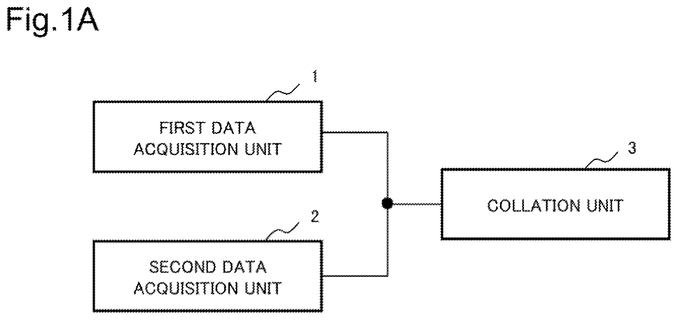

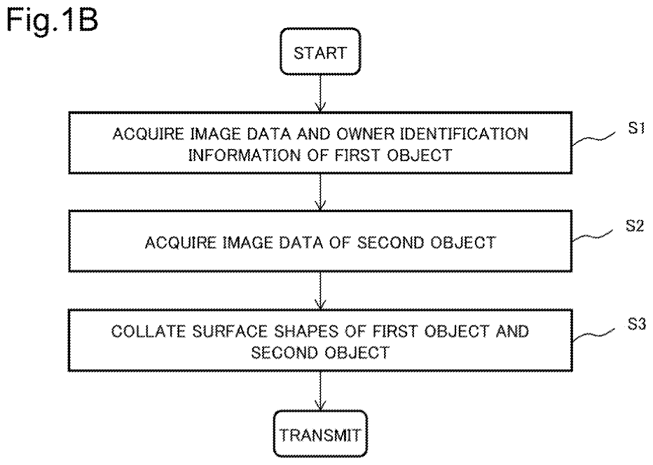

The first example embodiment of the present invention will be described in detail with reference to the drawings. FIG. 1A is a view illustrating the configuration of the management system of the present example embodiment. FIG. 1B is a view illustrating the operation flow of the management system of the present example embodiment.

The management system of the present example embodiment includes a first data acquisition unit 1, a second data acquisition unit 2, and a collation unit 3. The first data acquisition unit 1 acquires the first image data in which the first object is photographed and the identification information of the owner of the first object. The second data acquisition unit 2 acquires the second image data in which the second object is photographed. The collation unit 3 specifies the identification information of the owner of the first object by collating the feature of the surface pattern of the first object in the first image data with the feature of the surface shape of the second object in the second image data. By specification of the identification information of the owner by the collation unit 3, it is possible to determine whether the second object is belongings of the owner of the first object.

The surface pattern refers to a surface pattern unique to an individual naturally occurring in the manufacturing process of an object. For example, the surface pattern is a fine groove, unevenness, or the like of the object surface. The surface pattern is different for each individual even for the same type of object. The surface pattern is also called an object fingerprint because it is unique to an object like a fingerprint of a human finger.

Next, the operation of the management system of the present example embodiment will be described with reference to FIG. 1B. The first data acquisition unit 1 acquires image data of the first object and the identification information of the owner of the first object (step S1). The second data acquisition unit 2 acquires image data of the second object (step S2). Using the first image data and the second image data, the collation unit 3 collates the feature of the surface pattern of the first object with the feature of the surface pattern of the second object, and specifies the identification information of the owner of the first object (step S3).

When collating the feature of the surface pattern of the first object with the feature of the surface pattern of the second object and specifying the identification information of the owner of the first object, the collation unit 3 compares the surface pattern of the second object with the feature of the surface pattern of the first object, and determines whether the feature of the surface pattern of the first object is similar to the feature of the surface pattern of the second object by comparison. The collation unit 3 calculates cosine similarity, for example, in a case where both the feature of the surface pattern of the first object and the feature of the surface pattern of the second object are represented by a feature vector. The feature vector is, for example, multidimensional data indicating positions and feature amounts (density gradient of an image and the like) of a plurality of feature points of the surface pattern.

Upon determining that the surface pattern of the second object is similar to the surface pattern of the first object, the collation unit 3 specifies the identification information of the owner of the first object because the second object is the first object. This makes it possible to determine that the second object is belongings of the owner of the first object.

As an application example of the management system of the present example embodiment, it is a case where, using the surface pattern unique to each object, the owner of the object appearing in the second to image data is determined by determining whether the object appearing in the first image data registered in advance together with the identification information of the owner is similar to the object appearing in the second image data acquired at another time. By using, for identification of the object, the image data in which the surface pattern unique to each object is photographed, it is possible to identify whether to be the same object even if the objects are of the same or similar type and the difference cannot be visually discriminated. For example, when the surface patterns of the second object and the first object match, the second object and the first object are the same object, and from the identification information of the owner, it is possible to determine that the owner of the second object is the owner of the first object. By using image data in which the surface pattern unique to each object is photographed, it is possible to perform collation if there is image data in which the surface of the object is photographed. As a result, it is possible to obtain a highly accurate collation result while reducing the burden on the user. As described above, use of the management system of the present example embodiment makes it possible to specify the owner of an object without requiring complicated work.

### Second Example Embodiment

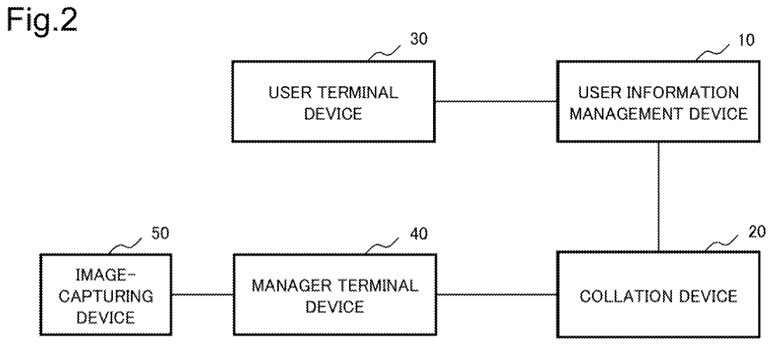

The second example embodiment of the present invention will be described in detail with reference to the drawings. FIG. 2 is a view illustrating an outline of the configuration of the management system of the present example embodiment. The management system of the present example embodiment includes a user information management device 10, a collation device 20, a user terminal device 30, a manager terminal device 40, and an image-capturing device 50.

The management system of the present example embodiment is assumed that the first image data of the surface pattern and the identification information of the owner of the first object whose owner is made clear by the identification information are transmitted from the user terminal device 30 to the user information management device 10 in advance and managed. Furthermore, it is assumed that the owner loses the first object, then the object is reported to the manager, and is managed as the second object by the user information management device 10. In this case, in order to search for the lost object, the collation device 20 of the management system acquires the first image and the identification information, as well as the second image data of the surface pattern of the second object whose owner is unknown due to the loss of the first object. The collation device 20 collates the first image with the second image. Then, in a case where the feature of the surface pattern of the first object is similar to the feature of the surface pattern of the second object, the collation device 20 specifies the owner of the second object from the identification information by specifying the identification information of the owner of the first object. In the management system of the present example embodiment, image data in which the object surface pattern is photographed is used as image data of the surface pattern of the object used for collation. In the second example embodiment, the surface pattern of an object is described as an object fingerprint.

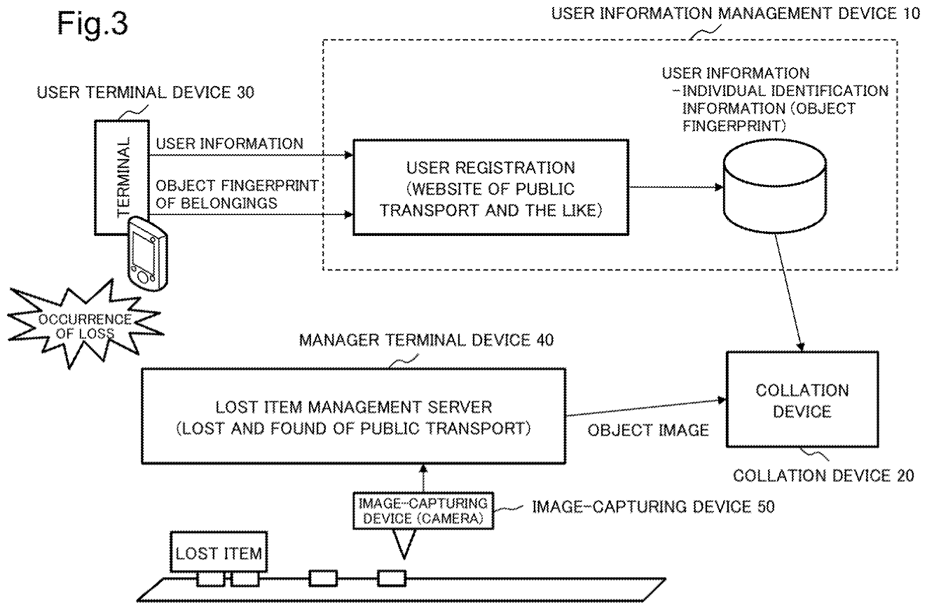

The management system of the present example embodiment can be used as a lost item management system in the lost and found in public transport as illustrated in FIG. 3, for example. In the example of FIG. 3, the user terminal device 30, which is a terminal device such as a smartphone owned by the user, inputs user information and acquires image data of the object fingerprint of the belongings. The user information includes information for identifying an individual such as a name, and contact information such as a telephone number and an e-mail address. The user information may include information of an account of a social networking service (SNS). The user information and the image data of the object fingerprint of the belongings are sent to the user information management device 10 run by a public transport operator or another operator, and the user information and the data of the object fingerprint, which is the identification information of the individual, are stored in association with each other. The lost item management system as in FIG. 3 may be installed in public transport that runs the lost and found, or may have a configuration in which a part of the management system is installed in an operator other than public transport and accessed from the lost and found via the network. For example, the lost item management system may be configured to access, via the network, the user information management device 10 and the collation device 20 managed by an operator other than public transport from the manager terminal device 40 installed in the lost and found. The user information management device 10 and the collation device 20 may be managed by different operators and connected to each other via the network.

In the lost and found that handles lost items in public transport or the like, the object fingerprint of a lost item whose owner is unknown is photographed by the image-capturing device 50. The lost item management server, that is, the manager terminal device 40 sends the collation device 20 the image data of the object fingerprint of the lost item photographed by the image-capturing device 50. The collation device 20 collates the object fingerprint photographed by the image-capturing device 50 of the lost and found with an object fingerprint registered in the user information management device 10, and specifies the identification information of the owner of the first object when the feature of the object fingerprint of the first object is similar to the feature of the object fingerprint of the second object. When there is image data in which the object fingerprints are similar to each other, the lost item associated with the object fingerprint photographed by the image-capturing device 50 is determined to be the belongings of the owner associated with the object fingerprint registered in the user information management device 10.

Similarity is not limited to a case where the object fingerprint photographed by the image-capturing device 50 and the object fingerprint registered in the user information management device 10 match by 100%, and may include an allowable value of matching in a range of equal to or more than 90%, for example, matching by equal to or more than 95%. The reference value in the range of similarity may be a value other than the value described above. The reference of the range of similarity may be set using an index other than a numerical value as long as it can indicate whether two objects are similar.

The configuration of each device of the management system of the present example embodiment will be described.

[User Information Management Device]

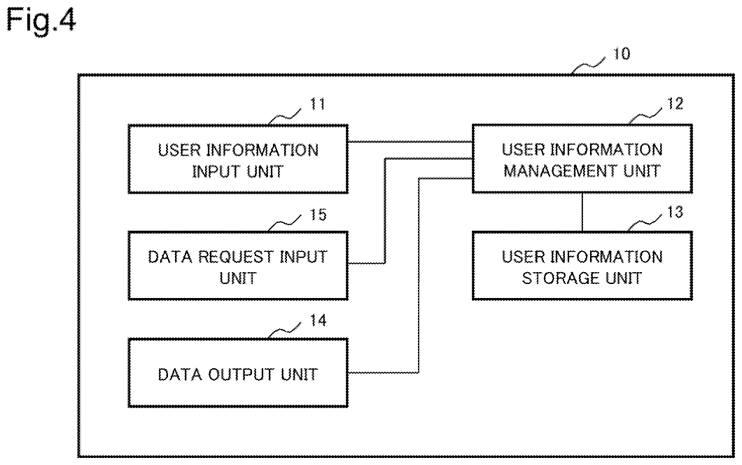

First, the configuration of the user information management device 10 will be described. FIG. 4 is a view illustrating the configuration of the user information management device 10. The user information management device 10 includes a user information input unit 11, a user information management unit 12, a user information storage unit 13, a data output unit 14, and a data request input unit 15. The user information management device 10 is a device that manages the information registered by the user, the identification information and contact of the user, and the image data of the object fingerprint of the user's belongings.

The user information input unit 11 receives the user information sent from the user terminal device 30, that is, the identification information of the user and the contact user information, and the image data of the object fingerprint of the user's belongings. The user information input unit 11 outputs the user information and the image data to the user information management unit 12.

The user information management unit 12 stores, in the user information storage unit 13, the user information and the image data of the object fingerprint of the user's belongings in association with each other. As the identification information of the user in the user information, an identifier (ID) assigned to each user is used. As the identification information of the user, information of the contact of the user such as the telephone number or the mail address may be used instead of the ID exclusively assigned. As the identification information of the user, information associated with the individual, such as an account of an SNS, can also be used.

Based on a request from the collation device 20, the user information management unit 12 reads the image data of the object fingerprint from the user information storage unit 13 and sends it to the collation device 20 via the data output unit 14.

The user information storage unit 13 stores the user information and the image data of the object fingerprint of the user's belongings in association with each other.

The data output unit 14 transmits the image data of the object fingerprint to the collation device 20.

The data request input unit 15 receives a request for image data of the object fingerprint from the collation device 20. The data request input unit 15 outputs the request for image data to the user information management unit 12.

Each processing in the user information input unit 11, the user information management unit 12, the data output unit 14, and the data request input unit 15 is performed by executing a computer program on the central processing unit (CPU). The computer program for performing each processing is recorded in, for example, a hard disk drive. The CPU executes a computer program for performing each processing by reading the computer program onto the memory.

The user information storage unit 13 includes a storage device such as a nonvolatile semiconductor storage device or a hard disk drive, or a combination of those storage devices. The user information storage unit 13 may be provided outside the user information management device 10 and connected via the network. The user information management device 10 may be configured by combining a plurality of information processing devices.

[Collation Device]

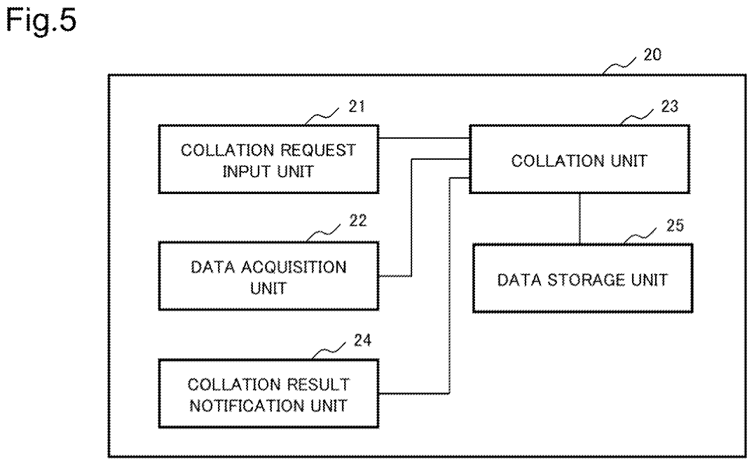

The configuration of the collation device 20 will be described. FIG. 5 is a view illustrating the configuration of the collation device 20. The collation device 20 includes a collation request input unit 21, a data acquisition unit 22, a collation unit 23, a collation result notification unit 24, and a data storage unit 25.

The collation request input unit 21 receives input of a collation request of the object fingerprint from the manager terminal device 40. The collation request input unit 21 receives the image data of the object fingerprint of the collation target object and the collation request from the manager terminal device 40. The collation request input unit 21 outputs, to the collation unit 23, the image data of the object fingerprint of the collation target and the collation request.

The data acquisition unit 22 requests the image data of the object fingerprint registered in the user information management device 10, and acquires the image data of the object fingerprint from the user information management device 10. The data acquisition unit 22 outputs the acquired image data to the collation unit 23.

The collation unit 23 collates the object fingerprint of the image data for which the collation request has been received from the manager terminal device 40 with the object fingerprint of the image data registered in the user information management device 10, and determines the presence or absence of similarity. The collation unit 23 detects a feature point for each of the object fingerprints of the two pieces of image data, and determines whether the two object fingerprints are of the same object based on a similarity, which is a ratio at which the arrangement of feature points match each other. When the similarity of the arrangement of the feature points is equal to or greater than a preset reference, the collation unit 23 regards that the two object fingerprints are the object fingerprints of the same object.

When there is no object fingerprint similar to the object fingerprint of the image data for which the collation request has been received, the collation unit 23 sends, to the manager terminal device 40 via the collation result notification unit 24, information indicating that there is no image having a similar object fingerprint. Upon detecting an object fingerprint similar to the object fingerprint of the image data for which the collation request has been received, the collation unit 23 sends, to the manager terminal device 40 via the collation result notification unit 24, the user information associated with the image data of the object fingerprint.

The collation result notification unit 24 sends the manager terminal device 40 the collation result received from the collation unit 23.

The data storage unit 25 stores image data for which the object fingerprint is collated and the user information associated with the image data received from the user information management device 10.

Each processing in the collation request input unit 21, the data acquisition unit 22, the collation unit 23, and the collation result notification unit 24 is performed by executing a computer program on the CPU. The computer program for performing each processing is recorded in, for example, a hard disk drive. The CPU executes a computer program for performing each processing by reading the computer program onto the memory.

The data storage unit 25 includes a storage device such as a nonvolatile semiconductor storage device or a hard disk drive, or a combination of those storage devices.

[Manager Terminal Device]

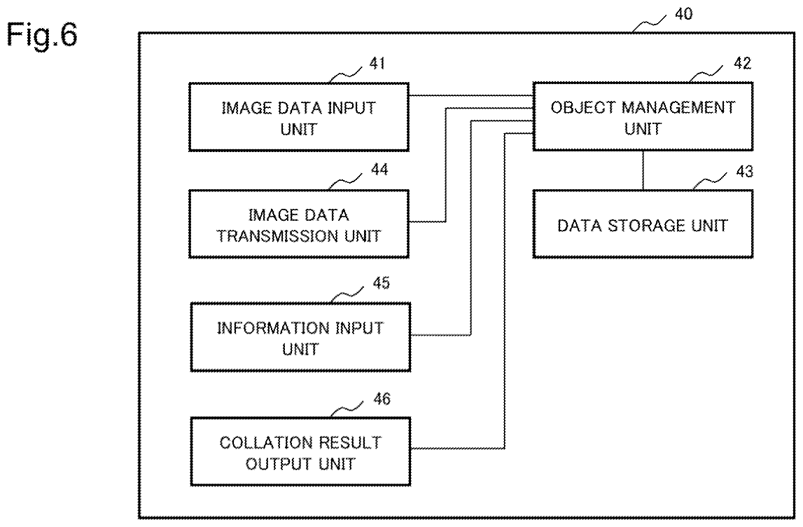

The configuration of the manager terminal device 40 will be described. FIG. 6 is a view illustrating the configuration of the manager terminal device 40. The manager terminal device 40 includes an image data input unit 41, an object management unit 42, a data storage unit 43, an image data transmission unit 44, an information input unit 45, and a collation result output unit 46.

The image data input unit 41 receives the image data of the object fingerprint of the management target object from the image-capturing device 50. In the example of FIG. 3, the image data input unit 41 acquires the image data of the object fingerprint of a lost item from the image-capturing device 50. The image data input unit 41 outputs the image data of the object fingerprint to the object management unit 42.

The object management unit 42 stores, in the data storage unit 43, the image data of the object fingerprint input from the image-capturing device 50 via the image data input unit 41. The object management unit 42 sends the image data of the object fingerprint photographed by the image-capturing device 50 to the collation device 20 via the image data transmission unit 44, and requests collation of the object fingerprint. The object management unit 42 acquires information of the collation result from the collation device 20 via the information input unit 45, and outputs the collation result via the collation result output unit 46.

The data storage unit 43 stores the image data of the object fingerprint photographed by the image-capturing device 50.

The image data transmission unit 44 transmits the image data photographed by the image-capturing device 50 to the collation device 20. The image data transmission unit 44 requests the collation device 20 for whether there is image data similar to the object fingerprint of the object photographed by the image-capturing device 50.

The collation result output unit 46 outputs information of the owner of the object photographed by the image-capturing device 50 based on the collation result. When indicating that the collation result has nothing similar to the object photographed by the image-capturing device 50, the collation result output unit 46 outputs that the owner is unknown.

Each processing in the image data input unit 41, the object management unit 42, the image data transmission unit 44, the information input unit 45, and the collation result output unit 46 is performed by executing a computer program on the CPU. The computer program for performing each processing is recorded in, for example, a nonvolatile semiconductor storage device. The CPU executes a computer program for performing each processing by reading the computer program onto the memory. The data storage unit 43 includes a nonvolatile semiconductor storage device. The above is the configuration of the manager terminal device 40.

The image-capturing device 50 photographs the surface shape of an object and generates image data of the object fingerprint. The image-capturing device 50 includes a complementary metal oxide semiconductor (CMOS) image sensor. As the image-capturing unit 31, an image sensor other than the CMOS may be used as long as it can photograph the object fingerprint. The image-capturing device 50 may be configured to include a lens module capable of changing magnification to photograph two images of the entire object and the object fingerprint on the surface of the object.

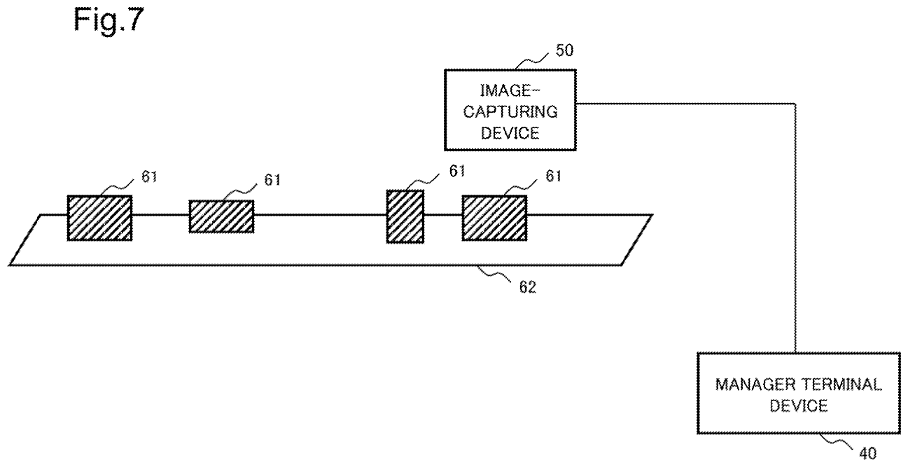

FIG. 7 is a view schematically illustrating an example of the configuration in which the image-capturing device 50 photographs image data of the object fingerprint to be input to the manager terminal device 40. In FIG. 7, a belt conveyor 62 conveys an object 61, which is a lost item. The image-capturing device 50 photographs the object fingerprint of the object 61 conveyed on the belt conveyor 62 and outputs image data of the object fingerprint.

[Operation Description]

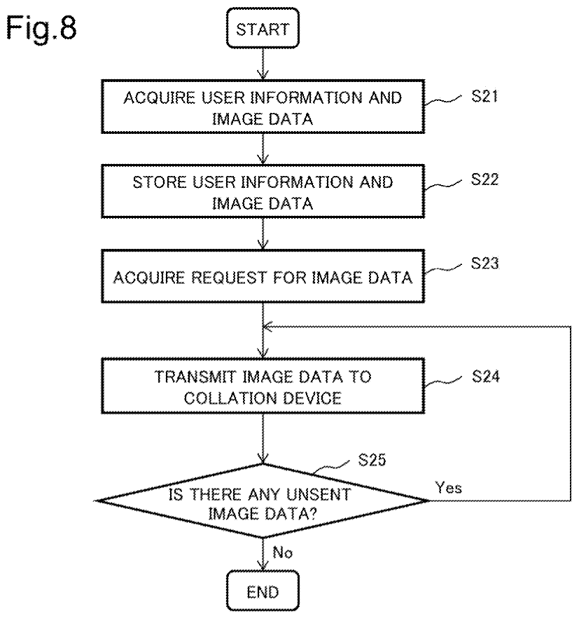

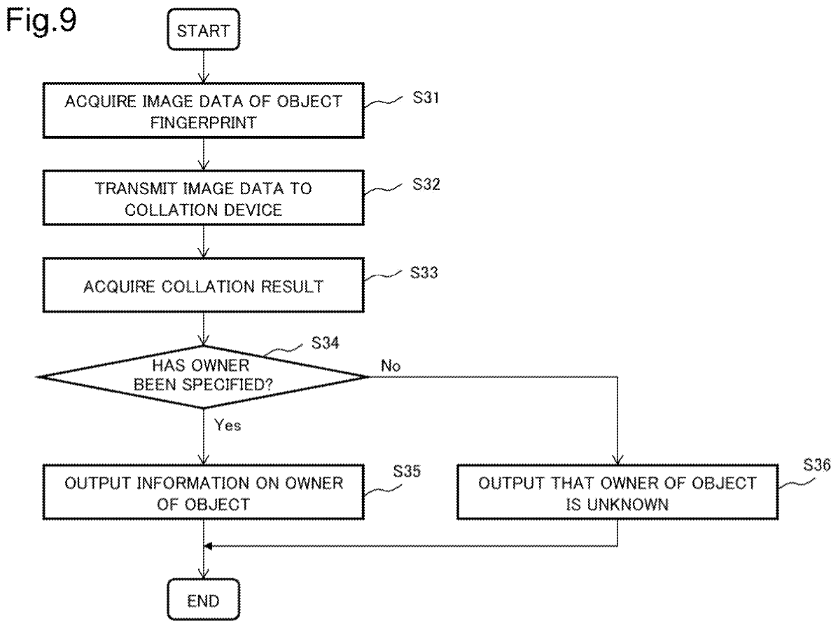

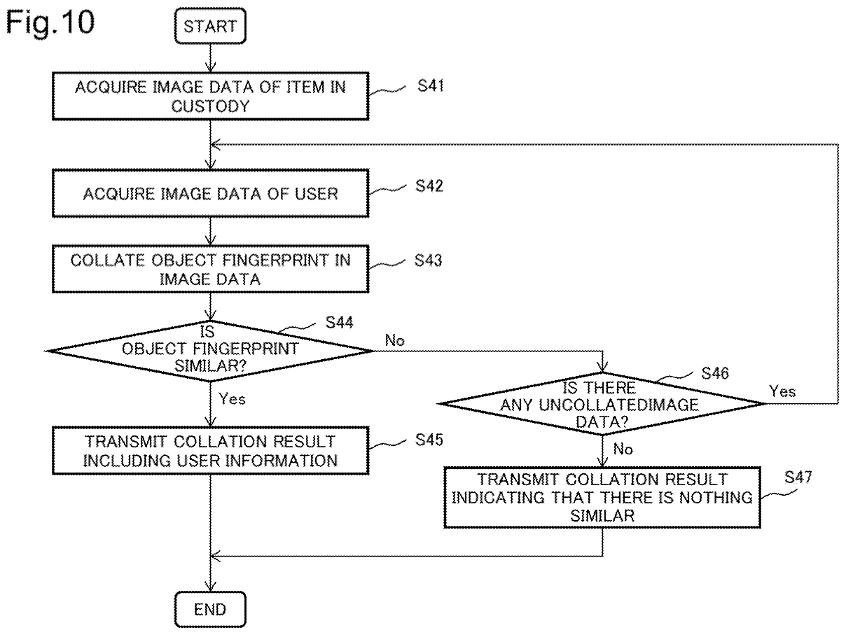

The operation of the management system of the present example embodiment will be described. FIG. 8 is a view illustrating the operation flow of the user information management device 10 illustrated in FIG. 4. FIG. 9 is a view illustrating the operation flow of the manager terminal device 40 illustrated in FIG. 6. FIG. 10 is a view illustrating the operation flow of the collation device 20 illustrated in FIG. 5.

First, the user operates a camera of the user terminal device 30 to register information of himself and image data of the object fingerprint of belongings. The user inputs the user's own name and contact to the user terminal device 30 as user information. As one or both of the user name and contact of the user information, information stored in advance in the user terminal device 30 may be used. The user terminal device 30 transmits the user information and the image data of the object fingerprint of the user's belongings to the user information management device 10.

The user information and the image data of the object fingerprint of the user's belongings sent to the user information management device 10 are input to the user information input unit 11 of the user information management device 10. In FIGS. 4 and 8, upon acquiring the user information and the image data of the object fingerprint of the user's belongings (step S21), the user information input unit 11 sends the user information management unit 12 the user information and the image data of the object fingerprint of the user's belongings.

Upon receiving the user information and the image data of the object fingerprint of the user's belongings, the user information management unit 12 stores, in the user information storage unit 13, the user information and the image data of the object fingerprint of the user's belongings in association with each other (step S22).

Next, in the manager terminal device 40, the image-capturing device 50 acquires the image data of the object fingerprint of the object 61, and the image data of the object fingerprint is input to the manager terminal device 40.

As illustrated in FIG. 7, upon photographing the object fingerprint of the object 61, the image-capturing device 50 sends image data of the object fingerprint to the manager terminal device 40. Upon photographing the object fingerprint, identification information for management of the object 61 may be associated with the image data of the object fingerprint. For example, the object 61 may be placed on a tray and conveyed, and the identification information of the tray may be used as the identification information of the object 61. In case of such configuration, the information on the tray is taken in by a reader reading an IC chip, a barcode, or the like added to the tray. The object 61 may be allocated with the identification information for management based on the order of photographing the object fingerprint. An image of the entire object 61 may be captured simultaneously with the object fingerprint. By capturing an image of the entire object 61, the type of the object 61 can be classified.

In FIGS. 6 and 9, the data of the object fingerprint of the object photographed by the image-capturing device 50 is input to the image data input unit 41 of the manager terminal device 40. Upon acquiring the image data of the object fingerprint (step S31), the image data input unit 41 sends the image data of the object fingerprint to the object management unit 42. Upon receiving the image data of the object fingerprint, the object management unit 42 stores the image data of the object fingerprint in the data storage unit 43. Upon storing the image data of the object fingerprint, the object management unit 42 sends the image data of the object fingerprint to the image data transmission unit 44. Upon receiving the image data of the object fingerprint, the object management unit 42 sends the collation device 20 the image data of the object fingerprint and a collation request (step S32).

The image data of the object fingerprint and the collation request are input to the collation request input unit 21 of the collation device 20. Upon receiving the image data of the object fingerprint and the collation request, the collation request input unit 21 sends the collation unit 23 the image data of the object fingerprint and the collation request. In FIGS. 5 and 10, the image data of the object fingerprint and the collation request are acquired (step S41), and the collation unit 23 stores the image data of the object fingerprint in the data storage unit 25. Upon storing the image data of the object fingerprint, the collation unit 23 requests the data acquisition unit 22 for the image data of the object fingerprint held by the user information management device 10.

Upon receiving the request for the image data of the object fingerprint, the data acquisition unit 22 sends the request for the image data of the object fingerprint to the user information management device 10.

The request for the image data of the object fingerprint is input to the user information management device 10. In FIGS. 4 and 80, upon acquiring the request for the image data of the object fingerprint (step S23), the user information management device 10 associates the user information with the image data of the object fingerprint and sends the data of the object fingerprint to the collation device 20 (step S24). When there is an unsent image in the stored image data of the object fingerprint, the user information management device 10 may repeat the processing of transmitting the image data of the object fingerprint. When the transmission of the stored object fingerprint to the collation device 20 is completed (No in step S25), the user information management device 10 ends the transmission of the image data of the object fingerprint to the collation device 20. In FIGS. 5 and 10, the image data of the object fingerprint sent to the collation device 20 is input to the data acquisition unit 22. Upon acquiring the image data of the object fingerprint (step S42), the data acquisition unit 22 sends the image data of the object fingerprint to the collation unit 23.

The collation unit 23 collates the image data of the object fingerprint sent from the user information management device 10 with the image data of the object fingerprint sent from the manager terminal device 40 stored in the data storage unit 25 (step S43). When the object fingerprint sent from the manager terminal device 40 is similar to the object fingerprint sent from the user information management device 10 (Yes in step S44), the collation unit 23 extracts the user information associated with the image data of the object fingerprint sent from the user information management device 10. The collation unit 23 notifies, via the data acquisition unit 22, the user information management device 10 that the collation is completed.

The collation device 20 may perform collation a plurality of times on the image data for which collation has been requested. When collation is performed a plurality of times, the frequency of collation may be changed according to the lapse of time or the number of times of collation. For example, in a case where a certain period of time has elapsed from the time when collation is newly requested, it is possible to specify the owner of the object discovered after the lapse of time while maintaining the frequency of the image data for which the collation is newly requested with a high possibility of specifying the owner by increasing the interval of collation.

Upon extracting the user information associated with the image data of the object fingerprint, the collation unit 23 sends the user information to the collation result notification unit 24. Upon receiving the user information, the collation result notification unit 24 sends the manager terminal device 40 a collation result including the user information (step S45).

The user information sent to the manager terminal device 40 is input to the information input unit 45 of the manager terminal device 40. In FIGS. 6 and 9, upon receiving the collation result (step S33), the object management unit 42 checks the content of the collation result. When the collation result includes the user information and the owner of the object has been specified (Yes in step S34), the user information is sent to the collation result output unit 46. Upon receiving the user information, the collation result output unit 46 outputs the user information as information of the owner of the object (step S35). For example, the collation result output unit 46 outputs, to a display device, as display data, the name and contact of the owner included in the user information as information of the owner of the object. The worker who sees the display notifies the owner of the object that there is an object in custody. In a case where the user information includes an e-mail address, the collation result output unit 46 may transmit, to the mail address, an e-mail notifying that the object is in custody. In a case where the user information includes an SNS account, the collation result output unit 46 may notify the SNS account that the object is in custody. In a case where a function of receiving a notification to the SNS is implemented in the user terminal device 30 as an application program, the collation result output unit 46 may notify the application program. The application program of the SNS may have a function of registering image data of belongings and user information into the user information management device 10.

In FIGS. 5 and 10, when the object fingerprint stored in the data storage unit 25 is not similar to the object fingerprint sent from the user information management device 10 (No in step S44), the collation unit 23 checks whether there is uncollated image data. When there is uncollated image data (Yes in step S46), the process returns to step S42, and the collation unit 23 next repeats the operation of comparing the object fingerprint sent from the user information management device 10 with the object fingerprint stored in the data storage unit 25.

When there is no uncollated image data and there is no similar object fingerprint even if collation is performed for all the image data (No in step S46), the collation unit 23 sends the collation result notification unit 24 a collation result indicating that there is no image data of a similar object fingerprint. Upon receiving the collation result indicating that there is no image data of a similar object fingerprint, the collation result notification unit 24 sends the manager terminal device 40 the collation result indicating that there is no image data of a similar object fingerprint (step S47). The collation result indicating that there is no image data of a similar object fingerprint sent to the manager terminal device 40 is input to the information input unit 45 of the manager terminal device 40.

In FIGS. 6 and 9, upon receiving the collation result (step S33), the object management unit 42 of the manager terminal device 40 checks the content of the collation result. When the collation result indicates that there is no image data of a similar object fingerprint and the owner has not been specified (No in step S34), the object management unit 42 sends the collation result output unit 46 information indicating that the owner of the object is unknown. Upon receiving the information that the owner of the object is unknown, the collation result output unit 46 outputs information that the owner of the object is unknown (step S36). For example, the collation result output unit 46 outputs, to the display device as display data, information that the owner of the object is unknown. The worker who sees the display keeps the object in custody as an object whose owner is unknown.

[Modification]

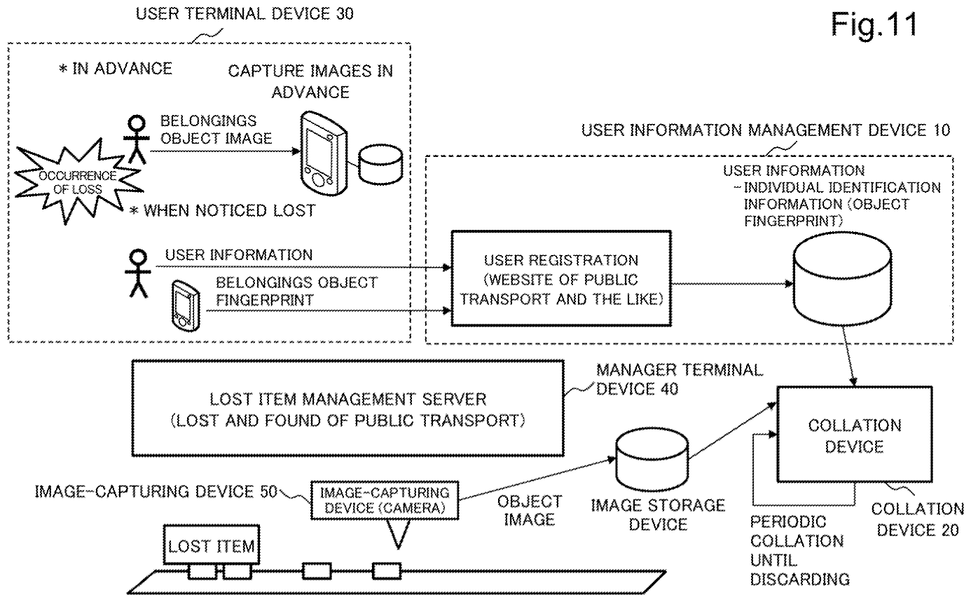

Another configuration example of the management system of the second example embodiment will be described. In the above example, the owner information and the image data of the object fingerprint are registered in advance in the user information management device 10. Instead of such configuration, the user information management device 10 may be notified of information of a target object when the user notices a lost item or a dropped item. FIG. 11 illustrates an example of a case where a configuration of notifying the user information management device 10 of information of a target object when the user notices a lost item or a dropped item is applied to the lost item management system in the lost and found in public transport as illustrated in FIG. 3.

In the example of FIG. 11, the user terminal device 30, which is a terminal device such as a smartphone owned by the user, inputs user information and acquires image data of the object fingerprint of the belongings. The user information includes information for identifying an individual such as a name, and contact information such as a telephone number and an e-mail address. The user information and the image data of the object fingerprint of the belongings are stored in the user terminal device 30. When noticing that his own belongings is lost, the user of the user terminal device 30 sends the image data of the object fingerprint of the belongings stored in the user terminal device 30 to the user information management device 10 run by a public transport operator or another operator.

In the lost and found of public transport or the like, the object fingerprint of a lost item whose owner is unknown is photographed by the image-capturing device 50. The lost item management server, that is, the manager terminal device 40 sends the collation device 20 the image data of the object fingerprint of the lost item photographed by the image-capturing device 50. The collation device 20 collates the object fingerprint transmitted by the user to the user information management device 10 with the object fingerprint photographed by the image-capturing device 50 of the lost and found, and checks whether there is image data having a similar object fingerprint. When there are image data in which the object fingerprints are similar to each other, the lost item associated with the object fingerprint photographed by the image-capturing device 50 matches the object associated with the object fingerprint transmitted from the user terminal device 30 by the user, and is determined to be the user's belongings.

It is described an operation in a case where the management system of the present example embodiment is applied to the configuration as illustrated in FIG. 11 that notifies the user information management device 10 of information of a target object when the user notices a lost item or a dropped item.

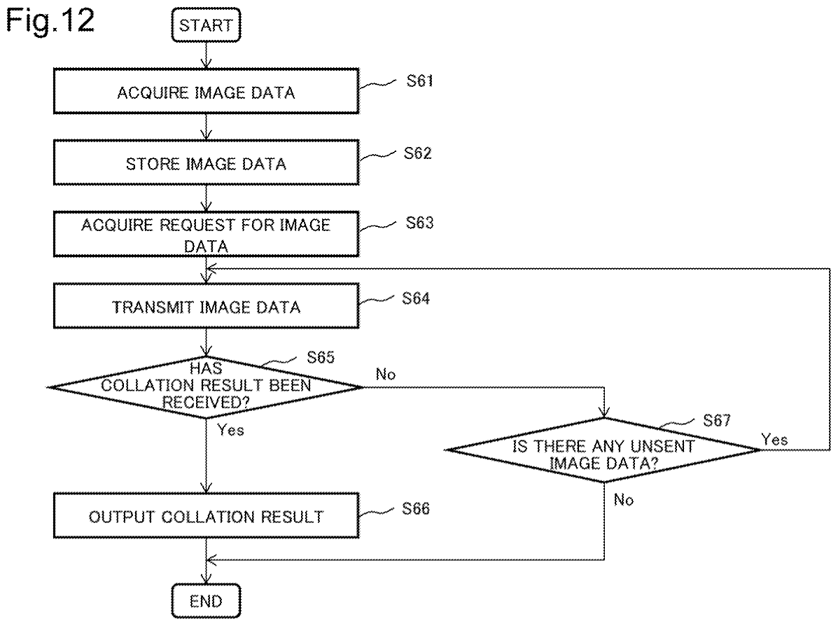

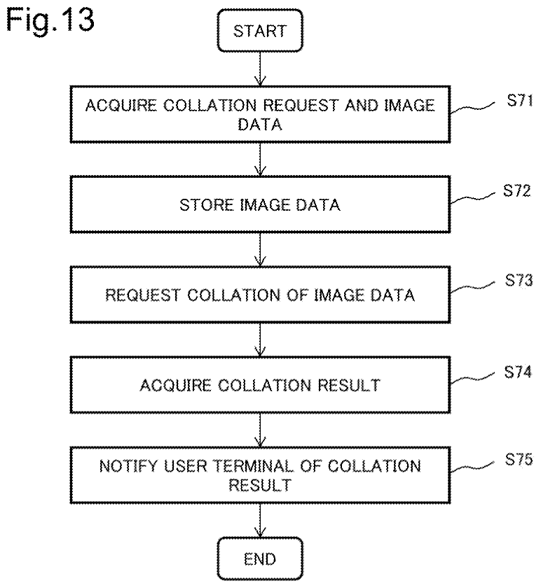

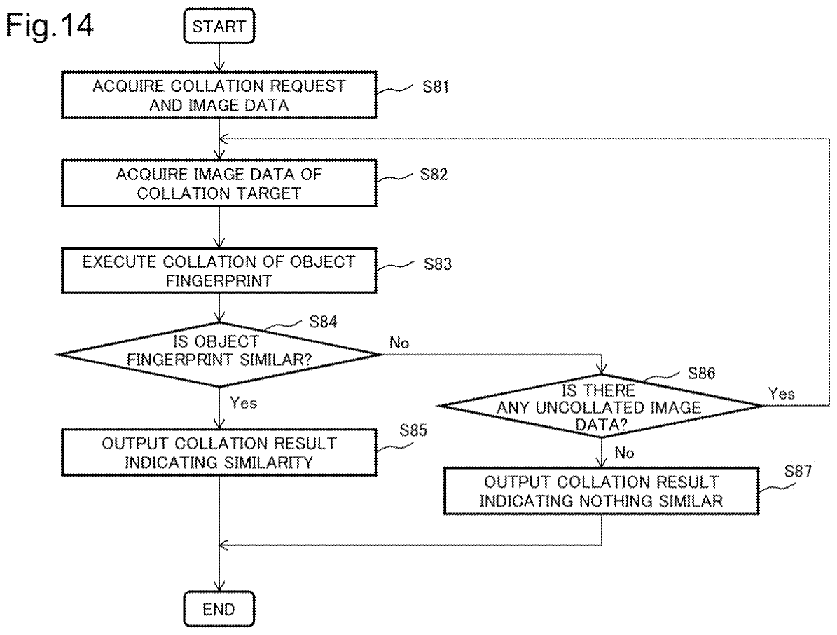

FIG. 12 is a view illustrating the operation flow of the manager terminal device 40 illustrated in FIG. 6. FIG. 13 is a view illustrating the operation flow of the user information management device 10 illustrated in FIG. 4. FIG. 14 is a view illustrating the operation flow of the collation device 20 illustrated in FIG. 5.

First, the user operates the camera of the user terminal device 30 to register information of the object fingerprint of the belongings. The user inputs the user's own name and contact to the user terminal device 30. As the name and contact of the user, information stored in advance in the user terminal device 30 may be used. The information input by the user is stored in the data storage unit in the user terminal device 30. When image data of a plurality of objects are stored, the above operation is repeated.

On the other hand, the image-capturing device 50 photographs the object fingerprint of the item in custody, and sends the manager terminal device 40 the image data of the object fingerprint of the object 61, which is the item in custody. Upon photographing the object fingerprint of the object 61, the image-capturing device 50 sends the image data of the object fingerprint to the manager terminal device 40. When photographing the object fingerprint, identification information for identifying the object 61 may be associated with the image data of the object fingerprint. For example, the object 61 may be placed on a tray and conveyed, and the identification information of the tray may be used as the identification information of the object 61. In case of such configuration, the information on the tray is taken in by a reader reading an IC chip, a barcode, or the like added to the tray. An image of the entire object 61 may be captured simultaneously with the object fingerprint. By capturing an image of the entire object 61, the type of the object 61 can be classified.

In FIGS. 6 and 12, the data of the object fingerprint of the item in custody is input to the image data input unit 41. Upon acquiring the image data of the object fingerprint (step S61), the image data input unit 41 sends the image data of the object fingerprint to the object management unit 42. Upon receiving the image data of the object fingerprint, the object management unit 42 stores the image data of the object fingerprint into the data storage unit 43 (step S62).

When whereabouts of the user's belongings becomes unknown, the user of the user terminal device 30 operates an operation unit of the user terminal device 30 to select image data of the belongings that has become unknown. The user terminal device 30 transmits a collation request and the image data to the user information management device 10.

The collation request and the image data of the object fingerprint of the user's belongings sent to the user information management device 10 are input to the user information input unit 11 of the user information management device 10. In FIGS. 4 and 13, upon acquiring the collation request and the image data of the object fingerprint (step S71), the user information input unit 11 sends the user information management unit 12 the user information and the image data of the object fingerprint of the user's belongings.

Upon receiving the collation request and the image data of the object fingerprint of the user's belongings, the user information management unit 12 stores, in the user information storage unit 13, the image data of the object fingerprint of the user's belongings and the user information attached to the image data (step S72).

Upon storing the image data of the object fingerprint, the object management unit 42 sends the image data transmission unit 44 the image data of the object fingerprint and a collation request. Upon receiving the image data of the object fingerprint and the collation request, the object management unit 42 sends the collation device 20 the image data of the object fingerprint and the collation request (step S73).

The image data of the object fingerprint and the collation request sent from the user information management device 10 are input to the collation request input unit 21 of the collation device 20. In FIGS. 5 and 14, upon acquiring the image data of the object fingerprint and the collation request (step S81), the collation request input unit 21 sends the collation unit 23 the image data of the object fingerprint and a collation request. Upon receiving the image data of the object fingerprint and the collation request, the collation unit 23 stores the image data of the object fingerprint into the data storage unit 25. Upon storing the image data of the object fingerprint, the collation unit 23 requests the data acquisition unit 22 for the image data of the object fingerprint held by the manager terminal device 40.

Upon receiving the request for the image data of the object fingerprint, the data acquisition unit 22 sends the request for the image data of the object fingerprint to the manager terminal device 40.

In FIGS. 6 and 12, the request for the image data of the object fingerprint is input to the information input unit 45. Upon acquiring the request for the image data of the object fingerprint (step S63), the information input unit 45 sends the object management unit 42 the request for the image data of the object fingerprint. Upon receiving the request for the image data of the object fingerprint, the object management unit 42 reads the image data of the object fingerprint from the data storage unit 43 and sends it to the image data transmission unit 44. Upon receiving the image data of the object fingerprint, the image data transmission unit 44 sends the data of the object fingerprint to the collation device 20 (step S64). In a state where the collation result has not been received (No in step S65), when there is an unsent image among the stored image data of the object fingerprint (Yes in step S67), the process returns to step S64, and the processing of transmission of the image data of the object fingerprint is repeated. When the transmission of the stored object fingerprint to the collation device 20 is completed (No in step S67), the transmission of the image data of the object fingerprint to the collation device 20 is ended.

The image data of the object fingerprint sent to the collation device 20 is input to the data acquisition unit 22. In FIGS. 5 and 14, upon receiving the image data of the object fingerprint of the item in custody (step S82), the data acquisition unit 22 sends the image data of the object fingerprint to the collation unit 23.

The collation unit 23 collates the image data of the object fingerprint sent from the manager terminal device 40 with the image data of the object fingerprint of the user's belongings stored in the data storage unit 25 (step S83). When the object fingerprint of the user's belongings is similar to the object fingerprint sent from the manager terminal device 40 (Yes in step S84), the collation unit 23 transmits, to the user information management device 10 and the manager terminal device 40 via the collation result notification unit 24, a collation result indicating that the object fingerprints are similar to each other (step S85). The collation unit 23 transmits the collation result to be sent to the user information management device 10 in association with the information of the place where the user's belongings is in custody. The collation unit 23 transmits the collation result to be sent to the manager terminal device 40 in association with the user information.

In FIGS. 4 and 13, upon receiving the collation result (step S74), the user information management unit 12 of the user information management device 10 transmits the collation result to the manager terminal device 40 via the data output unit 14 (step S75).

In FIGS. 5 and 14, when the object fingerprint of the user's belongings is not similar to the object fingerprint sent from the manager terminal device 40 in step S83 (No in step S84), the collation unit 23 checks whether there is uncollated image data. When there is uncollated image data (Yes in step S86), the process returns to step S82, and the collation unit 23 repeats the operation of comparing the object fingerprint to be next sent from the manager terminal device 40 with the object fingerprint stored in the data storage unit 25.

When there is no uncollated image data and there is no similar image data even if collation is performed for all the image data (No in step S86), the collation unit 23 sends the collation result notification unit 24 a collation result indicating that there is no image data of an object having a similar object fingerprint.

Upon receiving the collation result, the collation result notification unit 24 transmits, to the user information management device 10, the collation result indicating that there is no image data of an object having a similar object fingerprint (step S87).

In FIGS. 6 and 13, upon receiving the collation result from the collation device 20 (step S74), the user information management unit 12 of the user information management device 10 transmits the collation result to the manager terminal device 40 via the data output unit 14 (step S75).

Upon receiving the collation result, the user terminal device 30 outputs the collation result to a display unit. When the collation result is a result indicating that there is something matching the belongings, the user terminal device 30 displays, on the display unit, information of the place where it is in custody. When the collation result is a result indicating that there is nothing matching the belongings, the user terminal device 30 displays, on the display unit, information indicating that the belongings has not been found.

Upon receiving the collation result (Yes in step S65), the object management unit 42 stops transmission of the image data. The object management unit 42 notifies, via the collation result output unit 46, the worker of the owner information included in the collation result.

In the configuration as in FIG. 11, the collation request is made when the user notices the occurrence of a lost item such as a lost item, so that the collation target can be narrowed down to the lost items occurring within a certain period and the lost item notified from the user. This makes it possible to reduce the processing amount required for collation of the object fingerprint, and specify the owner.

In the configuration as in FIG. 11, the image data of the object fingerprint photographed by the user terminal device 30 may be registered in advance into the user information management device 10 or another server having a storage device. In such configuration, when noticing a lost item, the user selects an object to search for from objects registered in advance, and transmits, to the user information management device 10, information on the object of the target to search for. In such configuration, in a case where there is no collation request from the user side, collation may be performed in response to a request from the manager terminal device 40 side.

The management system of the present example embodiment can notify the owner of occurrence and custody of a lost item because data of the object fingerprint of the object has been registered even if the owner does not notice the loss when the lost item occurs. Therefore, it is possible to suppress the place and cost required for custody of the lost item. Even in a case where objects of the same design or a similar design are present at the same time as lost items, it is possible to suppress a workload required for specifying which object belongs to which person. Even in a case where objects of the same design or a similar design are present at the same time as lost items, it is possible to return the object to the correct owner without being confused with another person.

In the above example, the lost and found in a station, that is, a railway operator has been described as an example, but the management system of the present example embodiment can also be used for management of lost items in other transport such as buses, airplanes, and ships other than railways. The present invention is particularly effective in object management not only in transport but also in facilities used by many people such as public facilities, commercial facilities, sports grounds, and cultural facilities. The present invention can be used not only in a facility but also in an administrative agency for lost item management in a public space.

The management system of the present example embodiment can be used to specify a source of a fallen object by registering object fingerprints of actually used components together with identification information of vehicles and airframes for components that are likely to fall off, such as cars, trains, and aircrafts. Use for such applications makes it possible to make clear the whereabouts of responsibility of a fallen object, and it is also possible to suppress continuation of operation with the component being dropped and improve safety.

In the above example, the manager terminal device 40 is installed in only one place, but the manager terminal device 40 may be installed in a plurality of places such as different facilities of different operators or the same operator, and each may be configured to request the collation device 20 for collation. A plurality of the user information management devices 10 may be installed, and the collation device 20 may access each of the user information management devices 10 to acquire image data of the object fingerprint used for collation. All or any two of the user information management device 10, the collation device 20, and the manager terminal device 40 may be installed at the same place, or may be installed as an integrated device.

In the management system of the present example embodiment, the object fingerprint sent from the user terminal device 30 and the object fingerprint photographed by the image-capturing device 50 and sent from the manager terminal device 40 are collated by the collation device 20. When the collation result that the object fingerprints are similar is obtained in the collation device 20, the object associated with the object fingerprint sent from the user terminal device 30 and the object associated with the object fingerprint photographed by the image-capturing device 50 and sent from the manager terminal device 40 can be regarded as the same object. Therefore, by collating the object fingerprint, it is possible to discriminate that the owner of the object for which the image-capturing device 50 has photographed the object fingerprint is the user terminal device 30.

Since the management system of the present example embodiment only needs to obtain image data of the object fingerprint acquired by photographing the surface shape of an object, the user or the like is not required to have a high skill. Since a pattern unique to an object is used, it is possible to discriminate individual objects even if the objects are of the same type. Therefore, use of the management system of the present example embodiment makes it possible to specify the owner of an object without requiring complicated work.

### Third Example embodiment

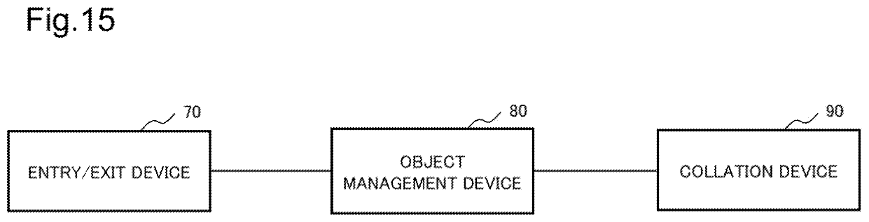

The third example embodiment of the present invention will be described in detail with reference to the drawings. FIG. 15 is a view illustrating the configuration of the management system of the present example embodiment. The management system of the present example embodiment includes an entry/exit device 70, an object management device 80, and a collation device 90. In the second example embodiment, the owner of an object away from the owner's hand is specified. The management system of the present example embodiment is characterized by specifying, by collation of object fingerprints, whether an object possessed by a leaving person from a zone where entry/exit is managed is identical to an object possessed by the person at the time of entry, and controlling a gate that manages entry/exit depending on whether the belongings is the same.

The configuration of each device of the management system of the present example embodiment will be described.

[Collation Device]

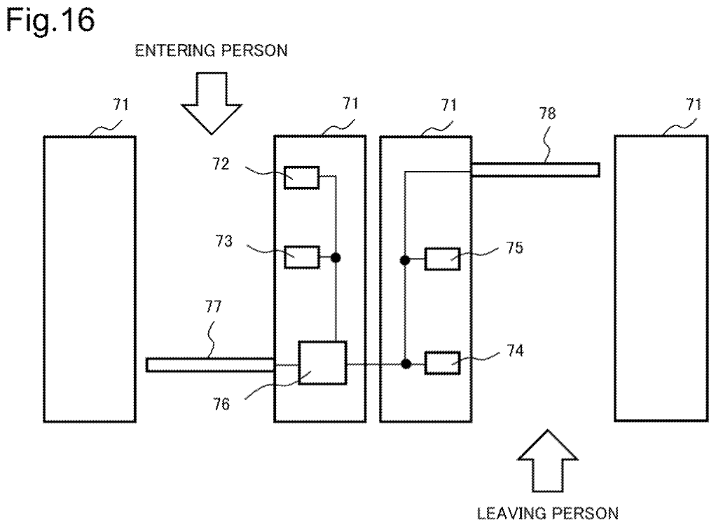

The configuration of the entry/exit device 70 will be described. FIG. 16 is a view illustrating the configuration of the entry/exit device 70. The entry/exit device 70 includes a gate 71, an entry side reading unit 72, an entry side image-capturing unit 73, an exit side reading unit 74, an exit side image-capturing unit 75, a gate control unit 76, an entry side door 77, and an exit side door 78.

The gate 71 is a body unit of the entry/exit device that manages entry into the zone managed by opening and closing of a door and exit from the managed zone.

The entry side reading unit 72 reads ID of an entering person. The entry side reading unit 72 reads the ID of the entering person from a contactless IC card held over a reading unit by the entering person. The entry side reading unit 72 may read an identification number unique to the IC card. The entry side reading unit 72 reads information from the IC card by near-field communication. The entry side reading unit 72 may be configured to optically read identification information indicated by a two-dimensional barcode or the like instead of the IC card.

The entry side image-capturing unit 73 photographs the object fingerprint of an object possessed by the entering person. The entry side image-capturing unit 73 includes a camera using a CMOS image sensor.

The exit side reading unit 74 reads the ID of a leaving person. The exit side reading unit 74 reads the ID of the leaving person from a contactless IC card held over the reading unit by the leaving person. The exit side reading unit 74 may read an identification number unique to the IC card. The exit side reading unit 74 reads information from the IC card by near-field communication. The exit side reading unit 74 may be configured to optically read identification information indicated by a two-dimensional barcode or the like instead of the IC card. The entry side reading unit 72 and the exit side reading unit 74 may specify entering persons and leaving persons by biometric authentication such as face authentication.

The exit side image-capturing unit 75 photographs the object fingerprint of an object possessed by the leaving person. The exit side image-capturing unit 75 includes a camera using a CMOS image sensor.

The gate control unit 76 manages entry/exit by controlling opening and closing of the entry side door 77 and the exit side door 78. The gate control unit 76 sends the object management device 80 the data acquired by the entry side reading unit 72, the entry side image-capturing unit 73, the exit side reading unit 74, and the exit side image-capturing unit 75. The gate control unit 76 receives, from the object management device 80, a collation result as to whether the belongings of the entering person and the leaving person match.

The gate control unit 76 includes one or a plurality of semiconductor devices. The processing in the gate control unit 76 may be performed by executing a computer program on the CPU.

By opening and closing, the entry side door 77 and the exit side door 78 manage whether entering persons and leaving persons can pass through.

In the configuration illustrated in FIG. 16, the entry side and the exit side gates are separate, but entry and exit may be performed bidirectionally in the same passage lane. The gate on the entry side and the gate on the exit side may be installed at distant positions. In a case of such configuration, the gate control unit 76 may be provided on each of the entry side and the exit side.

[Object Management Device]

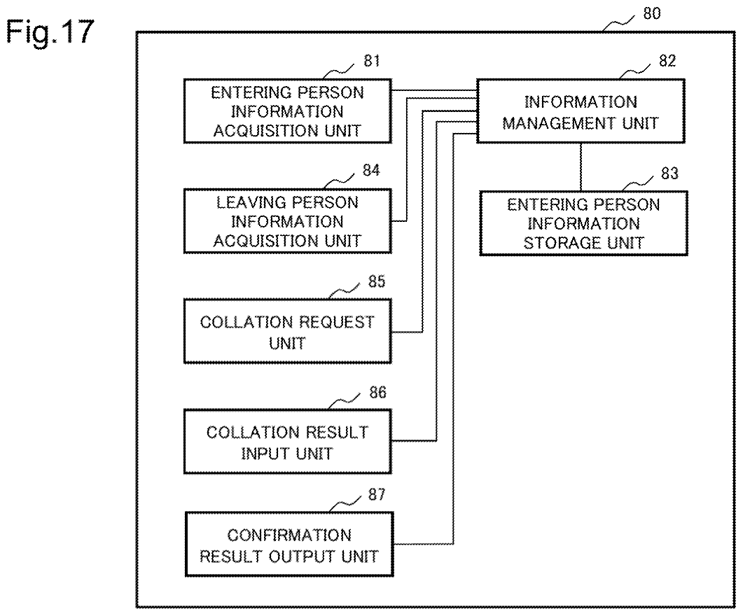

The configuration of the object management device 80 will be described. FIG. 17 is a view illustrating the configuration of the object management device 80. The object management device 80 includes an entering person information acquisition unit 81, an information management unit 82, an entering person information storage unit 83, a leaving person information acquisition unit 84, a collation request unit 85, a collation result input unit 86, and a check result output unit 87.

The entering person information acquisition unit 81 acquires, from the entry/exit device 70, identification information of an entering person and image data of the object fingerprint of belongings of the entering person.

The information management unit 82 stores, into the entering person information storage unit 83, the identification information of the entering person in association with the image data of the object fingerprint of the belongings of the entering person. The information management unit 82 requests the collation device 90 for collation of the object fingerprint of the belongings of the entering person of the identification information corresponding to the identification information of the leaving person with the object fingerprint of the belongings of the leaving person. Based on the collation result sent from the collation device 90, the information management unit 82 determines whether the belongings of the leaving person and the belongings of the entering person match together. The information management unit 82 receives a collation result that the object fingerprint of the object possessed by the leaving person matches the object fingerprint, and specifies the identification information. At this time, the information management unit 82 determines that the belongings of the leaving person are the same object as the belongings of the entering person associated with the specified identification information.

The entering person information storage unit 83 stores the identification information of the entering person and the image data of the object fingerprint of the belongings of the entering person.

The leaving person information acquisition unit 84 acquires, from the entry/exit device 70, the identification information of the leaving person and the image data of the object fingerprint of the belongings of the leaving person.

The collation request unit 85 transmits, to the collation device 90, the image data of the object fingerprint of the belongings of the entering person whose identification information matches the identification information of the leaving person and the image data of the object fingerprint of the belongings of the leaving person, and requests collation of the object fingerprints of the two pieces of image data.

The collation result input unit 86 acquires, from the collation device 90, a collation result between the object fingerprint of the belongings of the entering person whose identification information matches the identification information of the leaving person and the object fingerprint of the belongings of the leaving person.

The check result output unit 87 transmits, to the entry/exit device 70, a determination result as to whether the belongings match at the time of entry and at the time of exit.

Each processing in the entering person information acquisition unit 81, the information management unit 82, the leaving person information acquisition unit 84, the collation request unit 85, the collation result input unit 86, and the check result output unit 87 is performed by executing a computer program on the CPU. The computer program for performing each processing is recorded in, for example, a hard disk drive. The CPU executes a computer program for performing each processing by reading the computer program onto the memory.

The entering person information storage unit 83 includes a storage device such as a nonvolatile semiconductor storage device or a hard disk drive, or a combination of those storage devices.

[Collation Device]

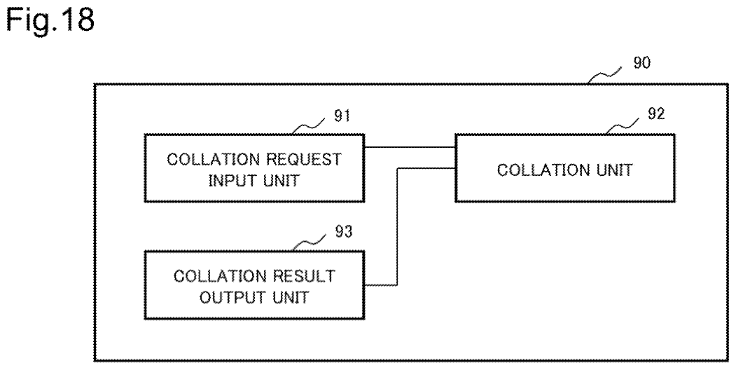

The configuration of the collation device 90 will be described. FIG. 18 is a view illustrating the configuration of the collation device 90. The collation device 90 includes a collation request input unit 91, a collation unit 92, and a collation result output unit 93.

The collation request input unit 91 receives input of image data of the object fingerprint of the belongings at the time of entry and image data of the object fingerprint of the belongings at the time of exit. The collation request input unit 91 outputs the received image data to the collation unit 92.

The collation unit 92 collates the object fingerprint of the belongings at the time of entry with the object fingerprint of the belongings at the time of exit, and determines the presence or absence of similarity. The collation unit 92 collates whether the image of the object fingerprint at the time of entry and the object fingerprint at the time of exit are similar, and if they are similar, regards that the owner of the object to which a second object fingerprint corresponds matches the owner of the object associated with a first object fingerprint, and specifies the identification information associated with the image data of the first object fingerprint. The collation unit 92 outputs the collation result to the collation result output unit 93.

The collation result output unit 93 sends, to the object management device 80, a collation result as to whether the object fingerprint of the belongings at the time of entry matches the object fingerprint of the belongings at the time of exit.

Each processing in the collation request input unit 91, the collation unit 92, and the collation result output unit 93 is performed by executing a computer program on the CPU. The computer program for performing each processing is recorded in, for example, a hard disk drive. The CPU executes a computer program for performing each processing by reading the computer program onto the memory.

[Operation Description]

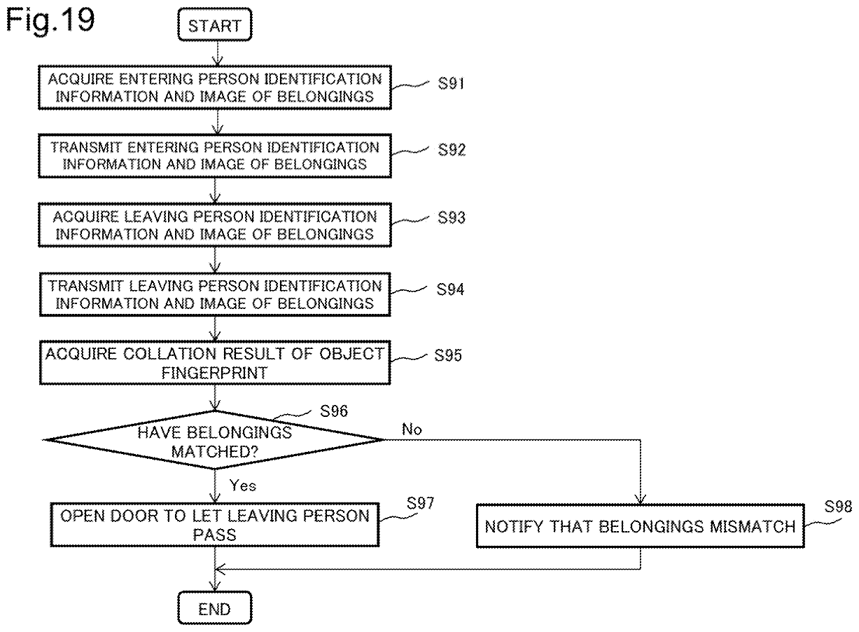

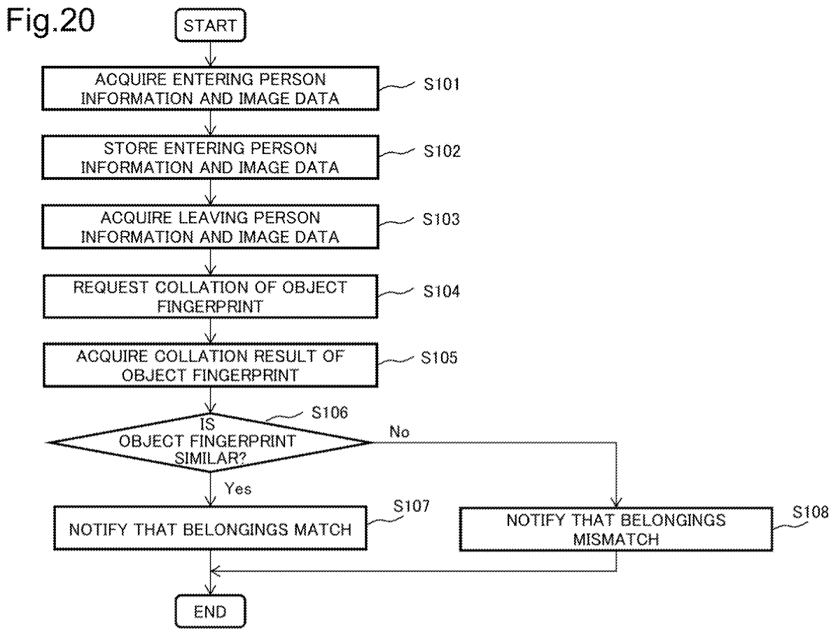

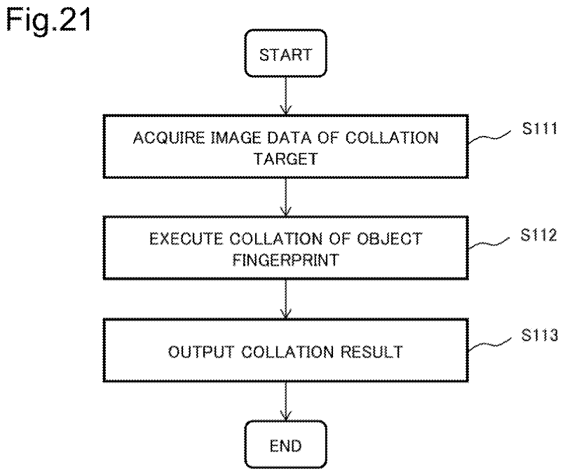

The operation of the management system of the present example embodiment will be described. FIG. 19 is a view illustrating the operation flow of the entry/exit device 70 illustrated in FIG. 16. FIG. 20 is a view illustrating the operation flow of the object management device 80 illustrated in FIG. 17. FIG. 21 is a view illustrating the operation flow of the collation device 90 illustrated in FIG. 18.

The user holds the IC card over the entry side reading unit 72. The entry side reading unit 72 reads the identification information of the IC card or the identification information of the user recorded in the IC card. Upon reading the identification information, the entry side reading unit 72 sends the identification information to the gate control unit 76.

The user holds the belongings over a camera of the entry side image-capturing unit 73. In FIGS. 16 and 19, the entry side image-capturing unit 73 photographs the object fingerprint of the belongings to acquire image data (step S91). Upon photographing the object fingerprint, the entry side image-capturing unit 73 sends the image data of the object fingerprint to the gate control unit 76.

Upon receiving the identification information and the image data of the object fingerprint, the gate control unit 76 controls the entry side door 77 to bring the door into an opening state, and closes the door when the user enters. The gate control unit 76 transmits the identification information and the image data of the object fingerprint to the object management device 80 as entering person information (step S92).

The entering person information is input to the entering person information acquisition unit 81 of the object management device 80. In FIGS. 17 and 20, upon acquiring the entering person information (step S101), the entering person information acquisition unit 81 transmits the entering person information to the information management unit 82. Upon receiving the entering person information, the information management unit 82 stores the entering person information into the entering person information storage unit 83 (step S102).

Next, the operation in a case where the user leaves will be described. The user holds the IC card over the exit side reading unit 74. The exit side reading unit 74 reads the identification information of the IC card or the identification information of the user recorded in the IC card. Upon reading the identification information, the exit side reading unit 74 sends the identification information to the gate control unit 76. The user holds the belongings over a camera of the exit side image-capturing unit 75. In FIGS. 16 and 19, the exit side image-capturing unit 75 photographs the object fingerprint of the belongings to acquire image data (step S93). Upon photographing the object fingerprint, the exit side image-capturing unit 75 sends the image data of the object fingerprint to the gate control unit 76. Upon receiving the identification information and the image data of the object fingerprint, the gate control unit 76 transmits the identification information and the image data of the object fingerprint to the object management device 80 as leaving person information (step S94).

The leaving person information is input to the leaving person information acquisition unit 84 of the object management device 80. In FIGS. 17 and 20, upon acquiring the leaving person information (step S103), the leaving person information acquisition unit 84 transmits the entering person information to the information management unit 82. Upon receiving the leaving person information, the information management unit 82 reads, from the entering person information storage unit 83, the image data of the object fingerprint of the entering person whose identification information matches the identification information of the leaving person information.

Upon reading the image data of the object fingerprint of the entering person, the information management unit 82 sends the collation request unit 85 the image data of the object fingerprint of the entering person associated with the identification information, the image data of the object fingerprint of the leaving person associated with the identification information, and a collation request of the two pieces of image data. Upon receiving the image data of the object fingerprint and the like, the collation request unit 85 sends the collation device 90 the image data of the object fingerprint, the identification information, and the collation request (step S104).

The image data of the object fingerprint is input to the collation request input unit 91 of the collation device 90. Upon acquiring the image data of the object fingerprint of the collation target in FIGS. 18 and 21 (step S111), the collation request input unit 91 sends the image data to the collation unit 92. Upon receiving the image data of the object fingerprint, the collation unit 92 collates the image of the object fingerprint at the time of entry with the image of the object fingerprint at the time of exit, and determines the presence or absence of similarity (step S112). The collation unit 92 collates whether the image of the object fingerprint at the time of entry and the object fingerprint at the time of exit are similar, and if they are similar, regards that the owner of the object to which the second object fingerprint corresponds matches the owner of the object associated with the first object fingerprint, and specifies the identification information of the entering person or the leaving person associated with the image data of the first object fingerprint.

Upon collating the image data of the object fingerprint, the collation unit 92 sends the collation result output unit 93 a collation result including the presence or absence of similarity of the object fingerprint and the specification result of the identification information. Upon receiving the collation result, the collation result output unit 93 outputs the collation result to the object management device 80 (step S113).

The collation result is input to the collation result input unit 86. In FIGS. 17 and 20, upon acquiring the collation result (step S105), the collation result input unit 86 sends the collation result to the information management unit 82. Upon receiving the collation result, the information management unit 82 checks whether the belongings at the time of entry and at the time of exit match each other with reference to the collation result.

When the object fingerprints of the two pieces of image data are similar to each other (Yes in step S106), the information management unit 82 transmits, to the entry/exit device 70 via the check result output unit 87, a notification of the collation result indicating that the belongings at the time of entry and at the time of exit match each other (step S107). When the object fingerprints of the two pieces of image data are not similar to each other (No in step S106), the information management unit 82 transmits, to the entry/exit device 70 via the check result output unit 87, a notification of the collation result indicating that the belongings at the time of entry and at the time of exit mismatch each other (step S108).

In FIGS. 16 and 19, upon acquiring the check result of whether the belongings match by the collation of the object fingerprint (step S95), the gate control unit 76 checks whether the belongings match. When the belongings match (Yes in step S96), the gate control unit 76 controls the exit side door 78 to bring the door into an opening state, lets the leaving person to pass, and closes the gate when the leaving person leaves (step S97).

When the belongings do not match (No in step S96), the gate control unit 76 maintains the door of the exit side door 78 in a state of being closed not to permit the leaving person to leave, and notifies the leaving person that the belongings do not match (step S98). When the belongings do not match, the gate control unit 76 may perform control of issuing an alert to notify the manager of being a leaving person who is not permitted to leave.

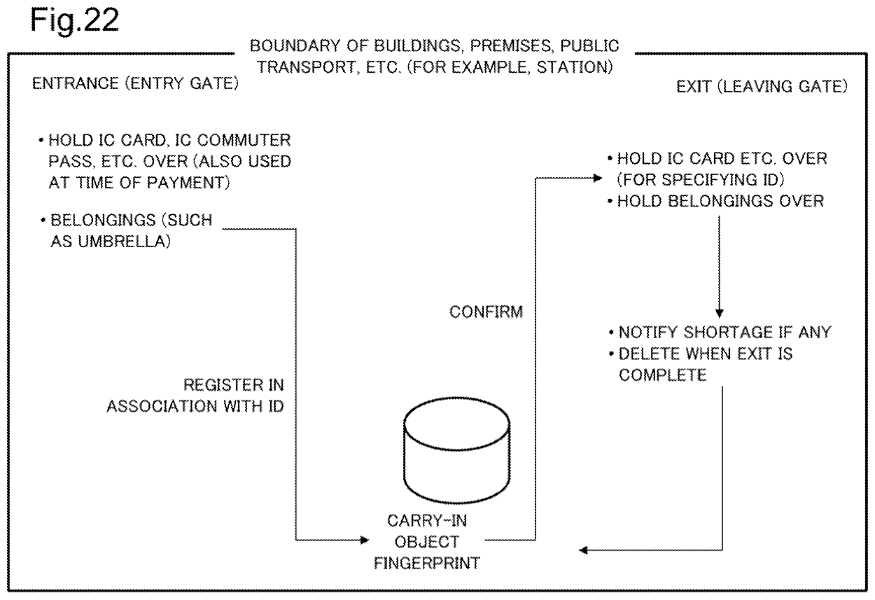

FIG. 22 is a view schematically illustrating an application example of the management system of the present example embodiment. In the example of FIG. 22, the management system is applied to a ticket gate of a railway station. In the example of FIG. 22, the identification information of an entering person is read at the time of entry from the IC card for paying the fare, and is stored in association with the object fingerprint of the belongings of the entering person. At the time of exit, the identification information of a leaving person is read from the same IC card, and the object fingerprint of the belongings of the leaving person is acquired. The object fingerprint of the belongings of the entering person and the object fingerprint of the belongings of the leaving person whose identification information match are collated, and in a case where the object fingerprints are similar and the belongings of the leaving person matches the belongings of the entering person, the leaving person is permitted to leave. When there are belongings at the time of exit that does not match the belongings at the time of entry, the leaving person is notified that there is shortage in the belongings.

By managing the belongings of the entering person and the leaving person in this manner, it is possible to prevent a person from leaving with an object possessed at the time of entry being mislaid in the zone. It is possible to prevent a person from leaving with an object different from the object possessed at the time of entry.

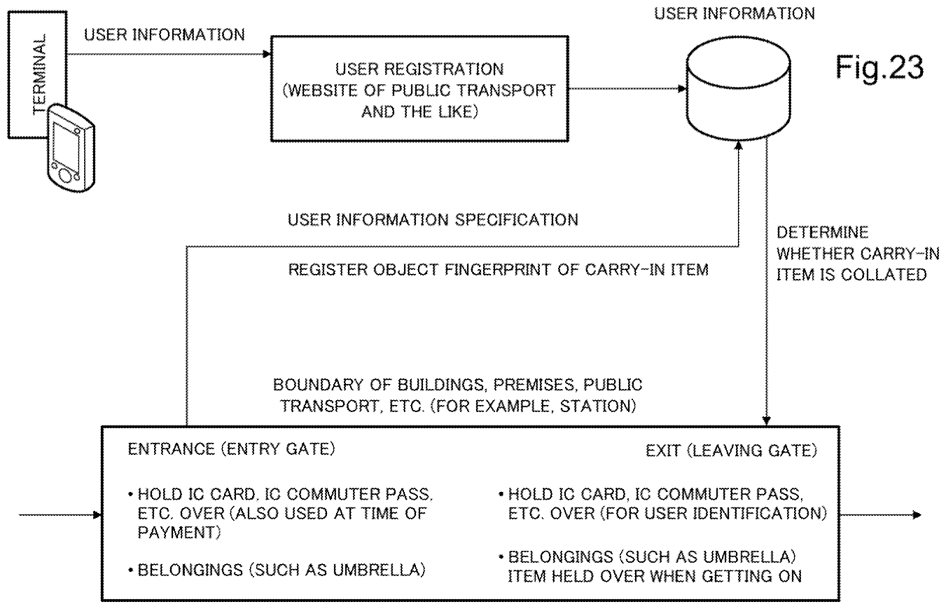

FIG. 23 is a view schematically illustrating an example in which the belongings management system of the present example embodiment is modified and applied. In the configuration of FIG. 23, image data of the object fingerprint of the belongings of the entering person is stored in advance via the terminal device of the entering person. In the configuration of FIG. 23, the image data of the object fingerprint of the belongings of the entering person stored in advance is stored in a server having a storage device, and is connected to the object management device 80 via the network. The image data of the object fingerprint of the belongings of the entering person may be stored in the object management device 80.

In the configuration of FIG. 23, the object fingerprint acquired at the time of exit is collated with the object fingerprint of the belongings of the entering person registered in advance, and in a case where the object fingerprints are similar to each other, it is determined that the belongings match each other, and the leaving person is permitted to leave. When there is an object fingerprint of the belongings at the time of exit that is not similar to the registered object fingerprint, the leaving person is notified that there is shortage in the belongings. In the configuration of FIG. 23, it is not necessary to acquire image data of the object fingerprint at the time of entry, and therefore it is possible to simplify the operation at the time of entry. Entry to a certain zone may be managed by two stages of gates, the first stage of gates may acquire image data of the object fingerprint, and the second stage of gates may take over the image data of the object fingerprint from the first stage of gates, and perform collation with the object fingerprint photographed at the time of exit.

Although FIGS. 22 and 23 exemplify entry/exit at a station, that is, in a railway operator, the management system of the present example embodiment can also be used for management of belongings of entering/leaving persons in other transport such as buses, airplanes, and ships other than railways. In particular, the present invention is more effective in applications requiring a high security level, such as management of carry-in items to aircraft. The present invention can also be applied to a case where the gate at the time of entry and the gate at the time of exit are installed at places separated from each other such as aircraft and railway. The management system of the present example embodiment may be applied to a case where entry of a person is not at the same time as luggage such as reception and delivery of checked luggage in aircraft or the like.

The management system of the present example embodiment can be applied to management of belongings of entering/leaving persons not only in transport but also in facilities used by many people such as public facilities, commercial facilities, sports grounds, and cultural facilities. When the object possessed by the entering person and the object in the zone where entry/exit is managed are of the same or similar type, by collating the object fingerprints of the belongings at the time of entry and at the time of exit, it is possible to prevent the entering person from taking out objects other than the belongings due to replacement or errors.

The management system of the present example embodiment can also be applied to management of carrying-in tools for maintenance of factories and equipment. For example, when performing maintenance of factory machinery and transport equipment, at the time of or prior to entry to the zone where work is performed, by acquiring the object fingerprints of carried-in tools and by collating the object fingerprints with the object fingerprints acquired from the belongings at the time of exit, it is possible to determine whether objects possessed at the time of entry are taken out. Such configuration makes it possible to prevent occurrence of defect caused by tools being mislaid in factory machinery and transport equipment. In the case of such configuration, in a case where the same tool is carried in every time, by collating using the image data of the object fingerprints registered in advance and the image data of the object fingerprints photographed at the time of exit, it is possible to improve the convenience at the time of entry.

The management system of the present example embodiment can also be applied to an application of acquiring object fingerprints of belongings such as a plastic bottle at the time of entry in a stadium or the like, and specifying the person who has thrown or abandoned the plastic bottle or the like when it is thrown or abandoned.

The management system of the present example embodiment can also be used for management of shoes in a restaurant or the like. For example, by acquiring and storing, in association with each other, identification information of the user and the image of the object fingerprint of the shoes taken off by each user at the time of entry, and performing collation using the identification information of each user and the object fingerprint of the shoes to be delivered at the time of exit, it is possible to prevent the user from mistakenly taking shoes when leaving the restaurant. Since many shoes have similar or identical designs, the accuracy and efficiency of management are improved by determining as to whether the objects match by collation of the object fingerprints. The management system of the present example embodiment can also be applied to a case of managing a coat, a bag, and the like in a cloakroom in a hotel, a restaurant, or other facilities. In a case of performing management of shoes or management in a cloakroom, entry/exit management by a gate need not be performed.

Although the object management device 80 and the collation device 90 are separate devices, the two devices may be configured as an integrated device.

In the management system of the present example embodiment, the collation device 90 collates the object fingerprint of the belongings of the entering person and the object fingerprint of the belongings of the leaving person acquired by the entry/exit device 70, and the object management device 80 determines whether the same object is possessed at the time of entry and the time of exit. Since the management system of the present example embodiment performs collation using the object fingerprint unique to the object, it is possible to identify individual objects even if the objects are of the same type. Therefore, it is possible to determine whether the same object is held between at the time of entry and at the time of exit without erroneously recognizing a similar object to be identical. Therefore, by applying the management system of the present example embodiment to management of the belongings of entering/leaving persons, it is possible to prevent them from leaving in a state of not possessing what they possessed at the time of entry or in a state of possessing something different from they possessed at the time of entry.

### Fourth Example embodiment

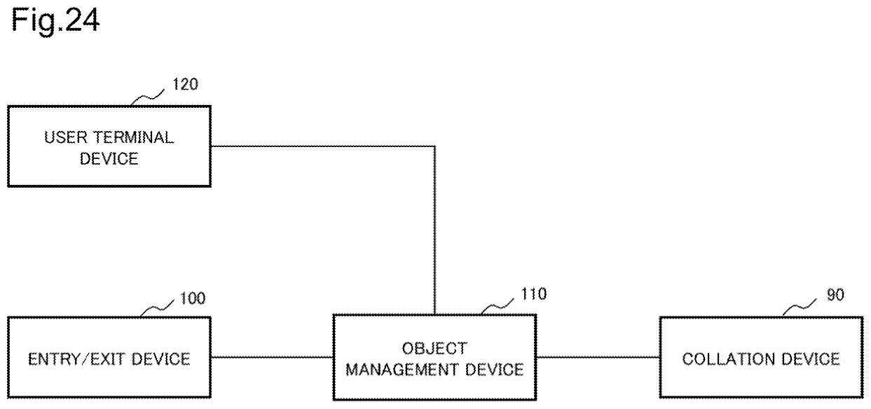

The fourth example embodiment of the present invention will be described in detail with reference to the drawings. FIG. 24 is a view illustrating the configuration of a management system of the present example embodiment. In the third example embodiment, by collating the object fingerprints of the belongings of the entering person and the leaving person, it is checked whether the belongings between at the time of entry and at the time of exit match each other. In addition to such configuration, the management system of the present example embodiment uses, as information of the belongings of the entering person, information selected by the entering person from among objects registered in advance.

The management system of the present example embodiment includes an entry/exit device 100, an object management device 110, the collation device 90, and a user terminal device 120. The configuration and function of the collation device 90 of the present example embodiment are the same as those of the third example embodiment. Therefore, description will be given below with reference to FIG. 18, which is a view illustrating the configuration of the collation device 90.

[Entry/Exit Device]

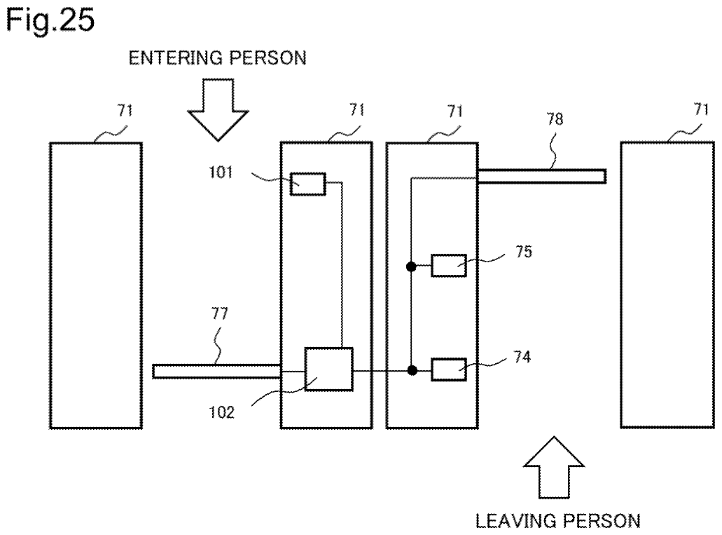

The configuration of the entry/exit device 100 will be described. FIG. 25 is a view illustrating the configuration of the entry/exit device 100. The entry/exit device 100 includes the gate 71, an entry side reading unit 101, the exit side reading unit 74, the exit side image-capturing unit 75, a gate control unit 102, the entry side door 77, and the exit side door 78. The configurations and functions of the gate 71, the exit side reading unit 74, the exit side image-capturing unit 75, the entry side door 77, and the exit side door 78 of the entry/exit device 100 of the present example embodiment are the same as the parts having the same names in the third example embodiment.

The entry side reading unit 101 reads a belongings list of the entering person. The entry side reading unit 101 reads the belongings list of the entering person from the user terminal device 120 held by the entering person over the reading unit. The entry side reading unit 101 and the user terminal device 120 perform wireless communication based on near-field communication (NFC) standard, for example.

The gate control unit 102 manages entry/exit by controlling opening and closing of the doors of the entry side door 77 and the exit side door 78. The gate control unit 102 sends the object management device 110 data of the belongings list acquired by the entry side reading unit 101 and data acquired by the exit side reading unit 74 and the exit side image-capturing unit 75. The gate control unit 102 receives, from the object management device 110, a collation result as to whether the belongings of the entering person and the leaving person match.

The gate control unit 102 includes one or a plurality of semiconductor devices. The processing in the gate control unit 102 may be performed by executing a computer program on the CPU.

In the configuration illustrated in FIG. 25, the entry side and the exit side gates are separate, but entry and exit may be performed bidirectionally in the same passage lane. The gate on the entry side and the gate on the exit side may be installed at distant positions. In a case of such configuration, the gate control unit 102 may be provided on each of the entry side and the exit side.

[Object Management Device]

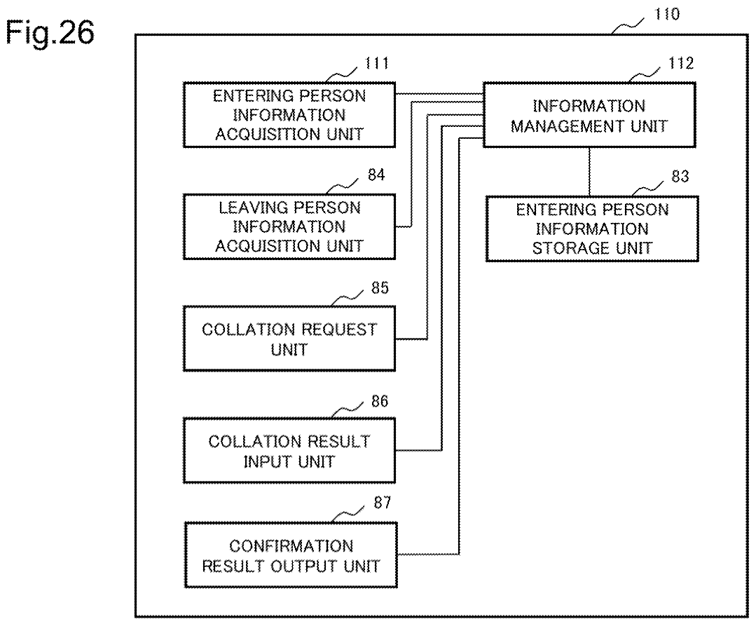

The configuration of the object management device 110 will be described. FIG. 26 is a view illustrating the configuration of the object management device 110. The object management device 110 includes an entering person information acquisition unit 111, an information management unit 112, the entering person information storage unit 83, the leaving person information acquisition unit 84, the collation request unit 85, the collation result input unit 86, and the check result output unit 87.

The configurations and functions of the entering person information storage unit 83, the leaving person information acquisition unit 84, the collation request unit 85, the collation result input unit 86, and the check result output unit 87 of the present example embodiment are the same as the parts having the same names of the third example embodiment.

The entering person information acquisition unit 111 acquires a belongings list of the entering person. The belongings list includes identification information of the entering person and image data of the object fingerprint of an object carried in by the entering person as belongings.

The information management unit 112 stores, into the entering person information storage unit 83, the identification information of the entering person and the image data of the object fingerprint in the belongings list. The information management unit 112 requests the collation device 90 for collation of the object fingerprint of the entering person of the identification information corresponding to the identification information of the leaving person with the object fingerprint of the belongings of the leaving person. Based on the collation result sent from the collation device 90, the information management unit 112 determines whether the belongings at the time of entry and the belongings at the time of exit match each other.

[User Terminal Device]

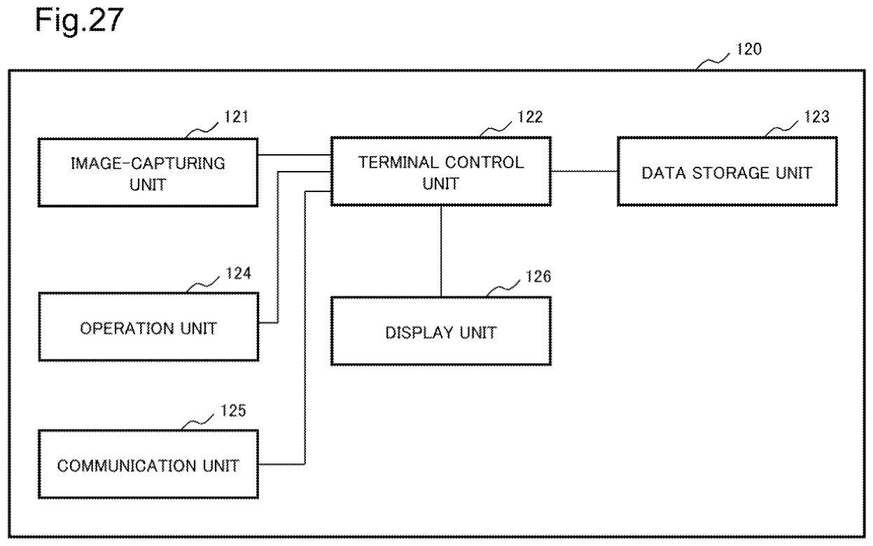

The configuration of the user terminal device 120 will be described. FIG. 27 is a view illustrating the configuration of the user terminal device 120. The user terminal device 120 includes an image-capturing unit 121, a terminal control unit 122, a data storage unit 123, an operation unit 124, a communication unit 125, and a display unit 126.

The image-capturing unit 121 photographs the object fingerprint of the user's belongings. The image-capturing unit 121 includes a CMOS image sensor. As the image-capturing unit 121, an image sensor other than the CMOS may be used as long as it can photograph the object fingerprint.

The terminal control unit 122 performs overall control of the user terminal device 120. The terminal control unit 122 generates a belongings list based on a selection result of the user. The belongings list includes identification information of the user and data of the object fingerprint of the belongings.

Each processing in the terminal control unit 122 is performed by executing a computer program on the CPU. The computer program for performing each processing is recorded in, for example, a nonvolatile semiconductor storage device. The CPU executes a computer program for performing each processing by reading the computer program onto the memory.

The data storage unit 123 stores image data of the object fingerprint photographed by the image-capturing unit 121. The data storage unit 123 stores, as the user information, information such as the name and contact of the user. The data storage unit 123 includes a nonvolatile semiconductor storage device.

The operation unit 124 receives input of a user's operation. The operation unit 124 receives input of user information, and input at the time of performing operation at the time of photographing by the image-capturing unit 121 and selecting belongings at the time of creating the belongings list. For example, the operation unit 124 may be formed as a module integrated with the display unit 126 as a touchscreen input device.

The communication unit 125 communicates with other devices. The communication unit 125 performs near-field communication, for example.

The display unit 126 displays information necessary for operation of the user terminal device 120. The display unit 126 displays object candidates when the belongings list is generated. The display unit 126 includes a liquid crystal display device or an organic EL display device.

[Operation Description]

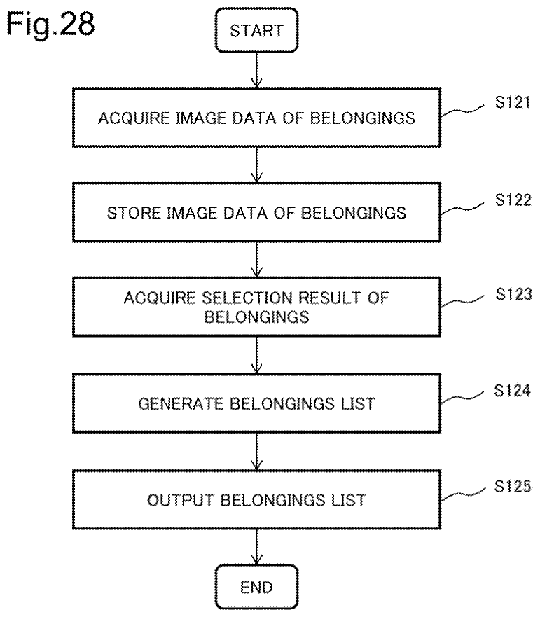

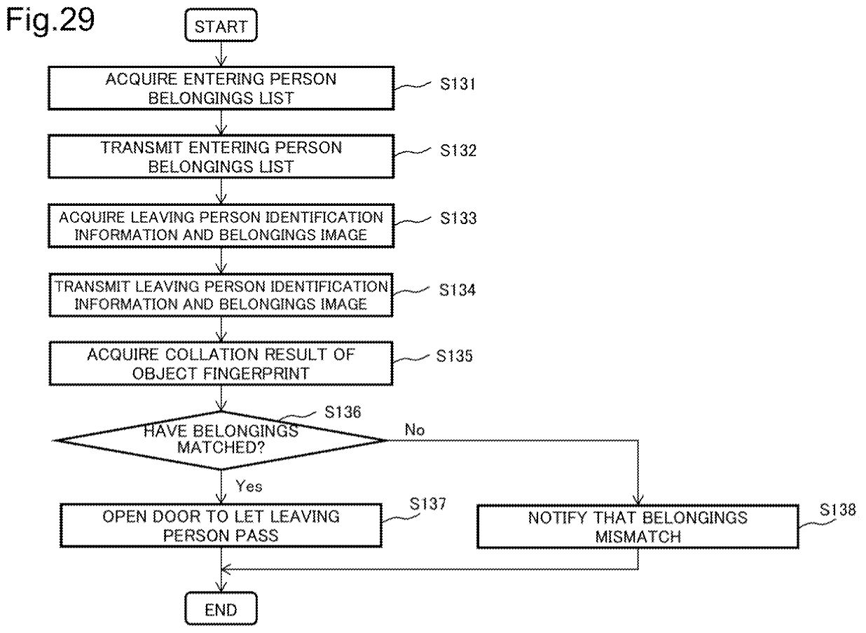

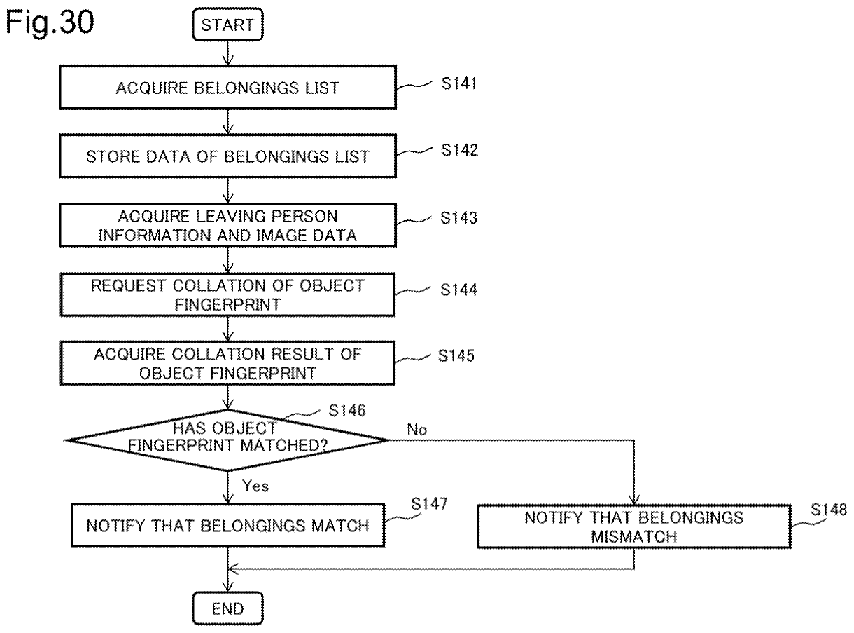

The operation of the management system of the present example embodiment will be described. FIG. 28 is a view illustrating the operation flow of the user terminal device 120 illustrated in FIG. 27. FIG. 29 is a view illustrating the operation flow of the entry/exit device 100 illustrated in FIG. 25. FIG. 30 is a view illustrating the operation flow of the object management device 110 illustrated in FIG. 26. The operation flow of the collation device 90 will be described with reference to FIG. 21. The configuration of the collation device 90 will be described with reference to FIG. 18.

First, the user photographs the object fingerprint of the belongings using a camera of the image-capturing unit 121 of the user terminal device 120. Upon photographing the object fingerprint, the image-capturing unit 121 sends image data of the object fingerprint to the terminal control unit 122. In FIGS. 27 and 28, upon acquiring the image data of the object fingerprint of the user's belongings (step S121), the terminal control unit 122 stores the image data of the object fingerprint into the data storage unit 123 (step S122). In a case where image data of the object fingerprints of a plurality of belongings are photographed, the image data are each stored in the data storage unit 123.

Next, the operation when the user enters a zone managed by the management system will be described. With reference to the information of the candidate of object displayed on the display unit 126, the user operates the operation unit 124 to select an object to carry in the management target zone as belongings. The operation unit 124 transmits information of the object selected by the user to the terminal control unit 122. Upon acquiring the selection result of the belongings (step S123), the terminal control unit 122 reads, from the data storage unit 123, the image data associated with the information of the object selected by the user. After the image data is read, data in which the identification information and the image data of the object carried in by the user as the belongings are combined is generated as a belongings list (step S124). In a case where there are a plurality of belongings, the belongings list includes identification information and image data of each carry-in object.

The user holds the user terminal device 120 over the entry side reading unit 101. Upon detecting that the holding over at the entry side reading unit 101, the terminal control unit 122 transmits the data of the belongings list to the entry side reading unit 101 via the communication unit 125 (step S125).

The entry side reading unit 101 reads the data of the belongings list transmitted from the communication unit 125. The entry side reading unit 101 sends the data of the belongings list to the gate control unit 102. In FIGS. 25 and 29, upon acquiring the data of the belongings list (step S131), the gate control unit 102 controls the entry side door 77 to bring the door into an opening state, and closes the door when the entering person enters. The gate control unit 102 sends the data of the belongings list to the object management device 110 (step S132).

The data of the belongings list is input to the entering person information acquisition unit 111 of the object management device 110. In FIGS. 26 and 30, upon acquiring the data of the belongings list (step S141), the entering person information acquisition unit 111 sends the data of the belongings list to the information management unit 112. Upon receiving the entering person information, the information management unit 112 stores, into the entering person information storage unit 83, the image data included in the data of the belongings list (step S142).

Next, the operation in a case where the user leaves will be described. The leaving person holds the user terminal device 120 over the exit side reading unit 74. The exit side reading unit 74 reads the identification information of the user from the user terminal device 120. Upon reading the identification information, the exit side reading unit 74 sends the identification information to the gate control unit 102.

The user holds the belongings over a camera of the exit side image-capturing unit 75. The exit side image-capturing unit 75 photographs the object fingerprint of the belongings. Upon photographing the object fingerprint, the exit side image-capturing unit 75 sends the image data of the object fingerprint to the gate control unit 102. In FIGS. 25 and 29, upon acquiring the identification information and the image data of the object fingerprint (step S133), the gate control unit 102 sends the object management device 110, as the leaving person information, the identification information and the image data of the object fingerprint (step S134).

The leaving person information is input to the leaving person information acquisition unit 114 of the object management device 110. In FIGS. 26 and 30, upon acquiring the leaving person information (step S143), the leaving person information acquisition unit 84 sends the leaving person information to the information management unit 112. Upon receiving the leaving person information, the information management unit 112 reads, from the entering person information storage unit 83, the image data of the object fingerprint of the entering person whose identification information matches the identification information of the leaving person information.

After the image data of the belongings list of the entering person is read, the image data of the object fingerprint of the belongings list of the entering person and the image data of the object fingerprint of the leaving person are sent to the collation request unit 85 together with a collation request.

Upon receiving the image data of the object fingerprints and the collation request, the collation request unit 85 sends the image data of the object fingerprints and the collation request to the collation device 90 (step S144).

The image data of the object fingerprints is input to the collation request input unit 91. In FIGS. 18 and 21, upon acquiring the image data of the object fingerprints of the collation target (step S111), the collation request input unit 91 sends the image data to the collation unit 92. Upon receiving the image data of the object fingerprints, the collation unit 92 collates the image of the object fingerprint at the time of entry with the image of the object fingerprint at the time of exit, and determines the presence or absence of collation (step S112).

Upon collating the image data of the object fingerprints, the collation unit 92 sends the collation result to the collation result output unit 93. Upon receiving the collation result, the collation result output unit 93 sends the collation result to the object management device 110 (step S113).

The collation result is input to the collation result input unit 86 of the object management device 110. Upon receiving the collation result, collation result input unit 86 sends the collation result to the information management unit 112. In FIGS. 26 and 30, upon receiving the collation result (step S145), the information management unit 112 checks whether the belongings at the time of entry and at the time of exit match each other with reference to the collation result.

When the object fingerprints of the two pieces of image data are similar to each other (Yes in step S146), the information management unit 112 sends the entry/exit device 100, via the check result output unit 87, the collation result indicating that the belongings at the time of entry and at the time of exit match each other (step S147). When the object fingerprints of the two pieces of image data are not similar to each other (No in step S146), the information management unit 112 sends the entry/exit device 100, via the check result output unit 87, a collation result indicating that the belongings at the time of entry and at the time of exit mismatch each other (step S148).

In FIGS. 25 and 29, upon acquiring the check result of whether the belongings match by the collation of the object fingerprint (step S135), the gate control unit 102 checks whether the belongings match. When the belongings match (Yes in step S136), the gate control unit 102 controls the exit side door 78 to bring the door into an opening state, lets the leaving person to pass, and closes the gate when the leaving person leaves (step S137).

When the belongings do not match (No in step S136), the gate control unit 102 maintains the door of the exit side door 78 in a state of being closed not to permit the leaving person to leave, and notifies the leaving person that the belongings do not match (step S138). When the belongings do not match, the gate control unit 76 may perform control of issuing an alert to notify the manager of being a leaving person who is not permitted to leave.

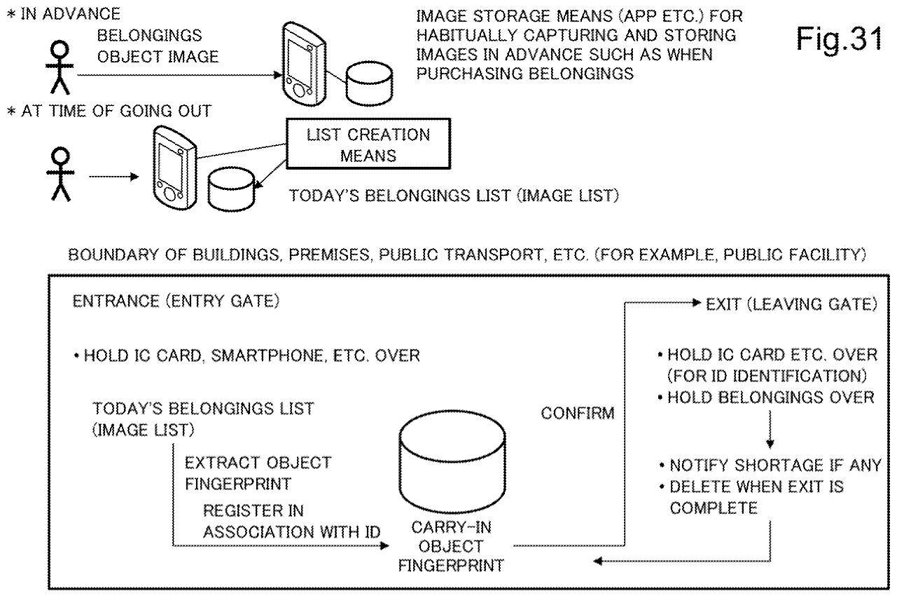

FIG. 31 is a view schematically illustrating an application example of the management system of the present example embodiment. In the example of FIG. 31, the management system is applied to an entrance of a public facility. In FIG. 31, an image of the object fingerprint of the user's belongings is photographed and stored in advance. In the example of FIG. 31, the user operates the terminal device to generate a belongings list. The belongings list includes image data of the object fingerprint of belongings and identification information of the user. The belongings list is sent to the entry/exit device side at the time of entry, and is stored in association with the object fingerprint of the belongings of the entering person. At the time of exit, the belongings list is acquired by reading the identification information of the leaving person from the same terminal device, and photographing the object fingerprint of the belongings of the leaving person. The object fingerprint of the belongings of the entering person and the object fingerprint of the belongings of the leaving person whose identification information match are collated, and in a case where the object fingerprints are similar to each other, it is determined that the object possessed at the time of exit matches the belongings of the entering person, the leaving person is permitted to leave. When there is an object possessed at the time of exit that does not match the belongings of the entering person, the leaving person is notified that there is shortage of the object possessed by the leaving person.

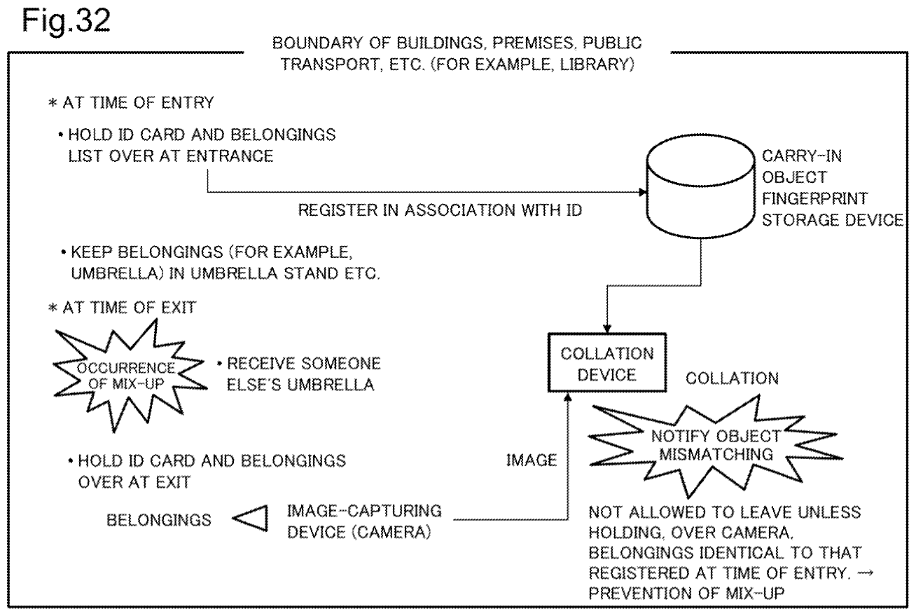

FIG. 32 is a view schematically illustrating an example in which the management system of the present example embodiment is modified and provided. In the example of FIG. 32, the image data of the object fingerprint of the belongings of the entering person is sent to the entry/exit device side as a belongings list similarly to FIG. 31. In the example of FIG. 32, it is configured that when there is an object possessed at the time of exit that does not match the object at the time of entry, exit is not permitted until they match.

The management system of the present example embodiment, similarly to the third example embodiment, can also be applied to management of belongings of entering/leaving persons in facilities used by many people such as transport, public facilities, commercial facilities, sports grounds, and cultural facilities.

The management system of the present example embodiment can also be applied to management of carrying-in tools for maintenance of factories and equipment. For example, when performing maintenance of factory machinery and transport equipment, at the time of or prior to entry to the zone where work is performed, it is possible to generate a belongings list of carried-in tools from tools possessed by the worker and whose image data of object fingerprints have been registered. By entering with reading the belongings list and collating the object fingerprints with the object fingerprints acquired from the belongings at the time of exit, it is possible to determine whether objects possessed at the time of entry are taken out. Such configuration makes it possible to prevent occurrence of defect caused by tools being mislaid in factory machinery and transport equipment.

In the management system of the present example embodiment, the collation device 90 collates the object fingerprints included in the belongings list of the entering person with the object fingerprint of the belongings of the leaving person, and the object management device 110 determines whether the same object is possessed at the time of entry and at the time of exit. Therefore, the management system of the present example embodiment is suitable to be applied to a case where objects to frequently carry in are determined in advance, and objects to carry in from among them are different for each entry. In such a case, since the collation between at the time of entry and at the time of exit can be performed in a more simplified manner, the management system of the present example embodiment can improve convenience of the user in entry/exit management while accurately managing the belongings.

The management systems of the third and fourth example embodiments may be applied only to check at the time of exit. For example, by registering in advance an object to always carry when going out, and when going out from a house or a workplace, by collating the object fingerprint registered at the entrance or the doorway with the object fingerprint of the belongings, it may be checked whether there is no shortage in the belongings. In a case of checking shortage in belongings or the like at the entrance of a house or the like, entry/exit by a gate may be eliminated. It is also possible to register in advance the object fingerprint of an object prohibited to take out, and check whether the prohibited object is taken out. Such configuration makes it possible to prevent shortage of belongings at the time of going out, and possible to prevent an object of another person from being taken out when the same or similar type object is possessed. In a case of applying only to check at the time of exit, a belongings list may be created from objects registered in advance, and the overage or shortage of the belongings may be checked at the time of going out.

The management system of the third example embodiment can also be used for an umbrella management system in an umbrella stand. In the umbrella management system, when a user places an umbrella on an umbrella stand at the time of entry to a facility or the like, the user holds the umbrella over a camera to acquire the object fingerprint of the umbrella, and data is stored together with identification information of the user read from an ID card or the like. At that time, management of entry/exit of the user may be omitted. When the user takes out the umbrella from the umbrella stand, the object fingerprint of the umbrella is acquired by the user holding the umbrella over the camera, and whether the objects match is checked by collation with the object fingerprint when the umbrella is placed based on the identification information of the user read from the ID card or the like. In an umbrella stand check system, in a case where image data of the object fingerprint of the umbrella and the identification information of the owner are registered in advance, the object fingerprint of the umbrella may be acquired only when being taken out. Since many umbrellas have the same design or similar designs, it is possible to manage the umbrellas while achieving both management accuracy and convenience by simplifying and applying the entry/exit management section from the management system of the third example embodiment.

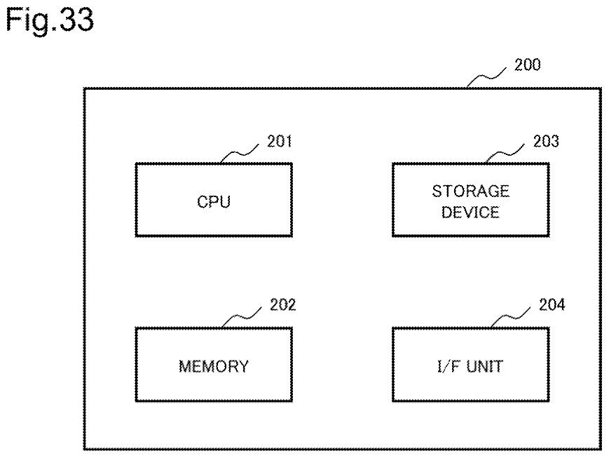

Processing in each device of the management system of each example embodiment can be performed by executing a computer program on a computer. FIG. 33 illustrates an example of the configuration of a computer 200 that executes a computer program for performing each processing in a learning device. The computer 200 includes a CPU 201, a memory 202, a storage device 203, and an interface (I/F) unit 204.

The CPU 201 reads and executes a computer program for performing each processing from the storage device 203. The memory 202 includes a dynamic random access memory (DRAM), and temporarily stores a computer program executed by the CPU 201 and data being processed. The storage device 203 stores a computer program executed by the CPU 201. The storage device 203 includes, for example, a nonvolatile semiconductor storage device. As the storage device 203, another storage device such as a hard disk drive may be used. The I/F unit 204 is an interface that inputs/outputs data to/from another device of the management system, a terminal of the network of the management target, and the like. The computer 200 may further include a communication module that communicates with another information processing device via a communication network.

The computer program performed in each processing can be stored in a recording medium and distributed. As a recording medium, for example, a magnetic tape for data recording or a magnetic disk such as a hard disk can be used. As the recording medium, an optical disk such as a compact disc read only memory (CD-ROM) can also be used. A nonvolatile semiconductor storage device may be used as the recording medium.

A part or the entirety of the above example embodiments can be described as the following supplementary notes, but are not limited to the following.

(Supplementary Note 1)

A management system including:

a first data acquisition means configured to acquire first image data in which a first object is photographed and identification information of an owner of the first object;

a second data acquisition means configured to acquire second image data in which a second object is photographed; and

a collation means configured to specify the identification information of an owner of the first object by collating a feature of a surface pattern of the first object in the first image data with a feature of a surface pattern of the second object in the second image data.

(Supplementary Note 2)

The management system according to supplementary note 1, further including:

a result output means configured to output information associated with the identification information of an owner of the first object having a feature of a surface pattern similar to a surface pattern of the second object.

(Supplementary Note 3)

The management system according to supplementary note 1 or 2, further including:

a data storage means configured to store the first image data of each of a plurality of the first objects, in which

the collation means collates the first image data selected from a plurality of pieces of the first image data having been stored with the second image data, and specifies the identification information of an owner of the first object.

(Supplementary Note 4)

The management system according to supplementary note 1 or 2, further including:

a second image-capturing means configured to photograph the second object and output the second image data; and

an object management means configured to request the collation means for collation of the second image data with the first image data.

(Supplementary Note 5)

The management system according to supplementary note 1, wherein

the second data acquisition means further acquires identification information of an owner of the second object, and

the collation means collates a feature of a surface pattern of the second object with a feature of a surface pattern of the first object whose identification information matches identification information of the second object.

(Supplementary Note 6)

The management system according to supplementary note 5, wherein

the first data acquisition means acquires identification information of an owner of the first object and image data of the first object when an owner of the first object enters a zone where an entering person is managed, and

the second data acquisition means acquires identification information of a leaving person from the zone, and acquires, as image data of the second object, image data of an object possessed by the leaving person.

(Supplementary Note 7)

The management system according to supplementary note 6, wherein

the first data acquisition means acquires the first image data of the first object carried into the zone by an entering person as a list generated based on the first image data photographed in advance.

(Supplementary Note 8)

The management system according to supplementary note 6 or 7, further including:

a data storage means configured to store image data of a plurality of objects, in which

the first data acquisition means acquires the first image data of the first object by reading from among the first image data stored in the data storage means based on the list.

(Supplementary Note 9)

The management system according to any of supplementary notes 6 to 8, further including:

a gate that manages entry to a zone where an entering person is managed and exit from the zone; and

a gate control means configured to control the gate based on a collation result by the collation means of the management system.

(Supplementary Note 10)

The management system according to supplementary note 9, wherein

when image data of the first object and image data of the second object do not match, the gate control means controls the gate in such a way as not to permit a leaving person to leave.

(Supplementary Note 11)

A management system including:

an entering person information acquisition means configured to acquire first image data in which a surface pattern of an object possessed by an entering person is photographed;

a leaving person information acquisition means configured to acquire second image data in which a surface pattern of an object possessed by a leaving person is photographed; and

a gate control means configured to control a gate based on a result of collating between a feature of a surface pattern of a first object in first image data and a feature of a surface pattern of a second object in the second image data.

(Supplementary Note 12)

The management system according to supplementary note 11, wherein

the entering person information acquisition means acquires the first image data selected in a terminal device possessed by the entering person, and

the leaving person information acquisition means acquires the second image data in which a surface pattern of an object possessed by the leaving person is photographed at the gate.

(Supplementary Note 13)

A management method including:

acquiring first image data in which a first object is photographed and identification information of an owner of the first object;

acquiring second image data in which a second object is photographed; and

specifying the identification information of an owner of the first object by collating a feature of a surface pattern of the first object in the first image data with a feature of a surface pattern of the second object in the second image data.

(Supplementary Note 14)

The management method according to supplementary note 13, further including: outputting information associated with the identification information of an owner of the first object having a feature of a surface pattern similar to a surface pattern of the second object.

(Supplementary Note 15)

The management method according to supplementary note 13 or 14, further including:

storing the first image data of each of a plurality of the first objects; and

collating the first image data selected from a plurality of pieces of the first image data having been stored with the second image data, and specifying the identification information of an owner of the first object.

(Supplementary Note 16)

The management method according to any of supplementary notes 13 to 15, further including:

photographing the second object and outputting the second image data; and

requesting for collation between the second image data and the first image data from a transmission side of the second image data.

(Supplementary Note 17)

The management method according to supplementary note 13, further including:

facquiring identification information of an owner of the second object; and

collating a feature of a surface pattern of the second object with a feature of a surface pattern of the first object whose identification information matches identification information of the second object.

(Supplementary Note 18)

The management method according to supplementary note 17, further including:

acquiring identification information of an owner of the first object and image data of the first object when an owner of the first object enters a zone where an entering person is managed; and

acquiring identification information of a leaving person from the zone, and acquiring, as image data of the second object, image data of an object possessed by the leaving person.

(Supplementary Note 19)

The management method according to supplementary note 18, further including: acquiring the first image data of the first object carried into the zone by an entering person as a list generated based on the first image data photographed in advance.

(Supplementary Note 20)

The management method according to supplementary note 19, further including:

storing image data of a plurality of objects; and

acquiring the first image data of the first object by reading, based on the list, from among the first image data having been stored.

(Supplementary Note 21)

The management method according to any of supplementary notes 18 to 20, further including:

controlling, based on a collation result, a gate that manages entry to the zone where an entering person is managed and exit from the zone.

(Supplementary Note 22)

The management method according to supplementary note 21, further including: controlling the gate in such a way as not to permit a leaving person to leave when image data of the first object and image data of the second object do not match.

(Supplementary Note 23)

A management method including:

acquiring first image data in which a surface pattern of an object possessed by an entering person is photographed;

acquiring second image data in which a surface pattern of an object possessed by a leaving person is photographed; and

controlling a gate based on a result of collating between a feature of a surface pattern of a first object in first image data and a feature of a surface pattern of a second object in the second image data.

(Supplementary Note 24)

The management method according to supplementary note 23, further including:

acquiring the first image data selected in a terminal device possessed by the entering person; and

acquiring the second image data in which an object possessed by the leaving person is photographed at the gate.

(Supplementary Note 25)

A management method including:

acquiring image data in which a surface pattern of an object is photographed;

receiving selection of image data of the object to be used for collation of belongings from the image data of each of the plurality of objects; and

outputting a surface pattern of selected image data as image data for collating with a feature of a surface pattern of an object photographed separately and specifying whether objects match.

(Supplementary Note 26)

A recording medium recording a computer program for causing a computer to execute

processing of acquiring first image data in which a first object is photographed and identification information of an owner of the first object,

processing of acquiring second image data in which a second object is photographed, and

processing of specifying the identification information of an owner of the first object by collating a feature of a surface pattern of the first object in the first image data with a feature of a surface pattern of the second object in the second image data.

(Supplementary Note 27)

A recording medium recording a computer program for causing a computer to execute

processing of acquiring first image data in which a surface pattern of an object possessed by an entering person is photographed,

processing of acquiring second image data in which a surface pattern of an object possessed by a leaving person is photographed, and

processing of collating between a feature of a surface pattern of a first object in first image data and a feature of a surface pattern of a second object in the second image data, and outputting a collation result for controlling a gate.

The present invention has been described above using the above-described example embodiments as exemplary examples. However, the present invention is not limited to the above-described example embodiments. It will be understood by those of ordinary skill in the art that various aspects may be made therein without departing from the spirit and scope of the present invention as defined by the claims.

### REFERENCE SIGNS LIST

1 first data acquisition unit
2 second data acquisition unit
3 collation unit
10 user information management device
11 user information input unit
12 user information management unit
13 user information storage unit
14 data output unit
15 data request input unit
20 collation device
21 collation request input unit
22 data acquisition unit
23 collation unit
24 collation result notification unit
25 data storage unit
30 user terminal device
40 manager terminal device
41 image data input unit
42 object management unit
43 data storage unit
44 image data transmission unit
45 information input unit
46 collation result output unit
50 image-capturing device
61 object
62 belt conveyor
70 entry/exit device
71 gate
72 entry side reading unit
73 entry side image-capturing unit
74 exit side reading unit
75 exit side image-capturing unit
76 gate control unit
77 entry side door
78 exit side door
80 object management device
81 entering person information acquisition unit
82 information management unit
83 entering person information storage unit
84 leaving person information acquisition unit
85 collation request unit
86 collation result input unit
87 check result output unit
90 collation device
91 collation request input unit
92 collation unit
93 collation result output unit
100 entry/exit device
101 entry side reading unit
102 gate control unit
110 object management device
111 entering person information acquisition unit
112 information management unit
120 user terminal device
121 image-capturing unit
122 terminal control unit
123 data storage unit
124 operation unit
125 communication unit
126 display unit
200 computer
201 CPU
202 memory
203 storage device
204 I/F unit

What is claimed is:

1. A management system comprising:
at least one memory storing instructions; and
at least one processor configured to access the at least one memory and execute the instructions to:
acquire first image data in which a first object is photographed and identification information of an owner of the first object;
acquire second image data in which a second object is photographed; and
specify the identification information of an owner of the first object by collating a feature of a surface pattern of the first object in the first image data with a feature of a surface pattern of the second object in the second image data.

2. The management system according to claim 1, wherein
the at least one processor is further configured to execute the instructions to:
output information associated with the identification information of an owner of the first object having a feature of a surface pattern similar to a surface pattern of the second object.

3. The management system according to claim 1, wherein
the at least one processor is further configured to execute the instructions to:
store the first image data of each of a plurality of the first objects;
collate the first image data selected from a plurality of pieces of the first image data having been stored with the second image data; and
specify the identification information of an owner of the first object.

4. The management system according to claim 1, wherein
the at least one processor is further configured to execute the instructions to:
photograph the second object;
output the second image data; and
request the collation means for collation of the second image data with the first image data.

5. The management system according to claim 1, wherein
the at least one processor is further configured to execute the instructions to:
acquire identification information of an owner of the second object; and
collate a feature of a surface pattern of the second object with a feature of a surface pattern of the first object whose identification information matches identification information of the second object.

6. The management system according to claim 5, wherein
the at least one processor is further configured to execute the instructions to:
acquire identification information of an owner of the first object and image data of the first object when an owner of the first object enters a zone where an entering person is managed;
acquire identification information of a leaving person from the zone; and
acquire, as image data of the second object, image data of an object possessed by the leaving person.

7. The management system according to claim 6, wherein
the at least one processor is further configured to execute the instructions to:
acquire the first image data of the first object carried into the zone by an entering person as a list generated based on the first image data photographed in advance.

8. The management system according to claim 6, wherein
the at least one processor is further configured to execute the instructions to:
store image data of a plurality of objects in a storage; and
acquire the first image data of the first object by reading from among the first image data stored in the storage based on the list.

9. The management system according to claim 6, wherein
the at least one processor is further configured to execute the instructions to:
control a gate based on a collation result, wherein the gate that manages entry to a zone where an entering person is managed and exit from the zone.

10. The management system according to claim 9, wherein
the at least one processor is further configured to execute the instructions to:
when image data of the first object and image data of the second object do not match, control the gate in such a way as not to permit a leaving person to leave.

11.-12. (canceled)

13. A management method comprising:
acquiring first image data in which a first object is photographed and identification information of an owner of the first object;
acquiring second image data in which a second object is photographed; and
specifying the identification information of an owner of the first object by collating a feature of a surface pattern of the first object in the first image data with a feature of a surface pattern of the second object in the second image data.

14. The management method according to claim 13, further comprising:
outputting information associated with the identification information of an owner of the first object having a feature of a surface pattern similar to a surface pattern of the second object.

15. The management method according to claim 13, further comprising:
storing the first image data of each of a plurality of the first objects; and
collating the first image data selected from a plurality of the first image data having been stored with the second image data, and specifying the identification information of an owner of the first object.

16. (canceled)

17. The management method according to claim 13, further comprising:
acquiring identification information of an owner of the second object; and
collating a feature of a surface pattern of the second object with a feature of a surface pattern of the first object whose identification information matches identification information of the second object.

18. The management method according to claim 17, further comprising:
acquiring identification information of an owner of the first object and image data of the first object when an owner of the first object enters a zone where an entering person is managed; and
acquiring identification information of a leaving person from the zone, and acquiring, as image data of the second object, image data of an object possessed by the leaving person.

19. The management method according to claim 18, further comprising:
acquiring the first image data of the first object carried into the zone by an entering person as a list generated based on the first image data photographed in advance.

20. The management method according to claim 19, further comprising:
storing image data of a plurality of objects; and
acquiring the first image data of the first object by reading, based on the list, from among the first image data having been stored.

21. The management method according to claim 18, further comprising:
controlling, based on a collation result, a gate that manages entry to the zone where an entering person is managed and exit from the zone.

22. The management method according to claim 21, further comprising:
controlling the gate in such a way as not to permit a leaving person to leave when image data of the first object and image data of the second object do not match.

23.-25. (canceled)

26. A non-transitory recording medium recording a computer program for causing a computer to execute
processing of acquiring first image data in which a first object is photographed and identification information of an owner of the first object,
processing of acquiring second image data in which a second object is photographed, and
processing of specifying the identification information of an owner of the first object by collating a feature of a surface pattern of the first object in the first image data with a feature of a surface pattern of the second object in the second image data.

27. (canceled)
